(19) United States
(12) Patent Application Publication
(10) Pub. No.: US 2013/0144697 A1
(43) Pub. Date: Jun. 6, 2013

(54) Socially Networked Business and Consumer Space

(71) Applicants: ZeMing M. Gao, Portland, OR (US); Pingyi Yan, ShenZhen (CN)

(72) Inventors: ZeMing M. Gao, Portland, OR (US); Pingyi Yan, ShenZhen (CN)

(73) Assignee: Coentre Ventures LLC, Portland, OR (US)

(21) Appl. No.: 13/563,696

(22) Filed: Jul. 31, 2012

Related U.S. Application Data
(60) Provisional application No. 61/513,602, filed on Jul. 31, 2011.

(51) Int. Cl. G06Q 30/02; G06Q 50/00

(52) U.S. Cl. CPC G06Q 30/0215; G06Q 50/01
USPC 705/14.17

(57) ABSTRACT

Creative energy of consumers is captured and incentivized by businesses when the businesses provide personal incentives that reflect the extent to which the consumers make productive contributions to a socially networked business and consumer space. The personal incentives provide consumers lower prices through coupons, rebates, or other discounts for various items sold or distributed by the businesses. Consumers that are more productive or active in the social space can receive lower pricing on items. The personalized incentive for a particular consumer may be based on the quantity and quality of product reviews provided by the consumer as well as other factors such as consumer loyalty to a particular merchant or business. This business and consumer space spans the brick-and-mortar as well as the online retail spaces allowing consumers to use a mobile device to make online purchases by scanning a tag on a tangible object in a brick-and-mortar store.

### RELATED APPLICATION

This application claims priority to U.S. Provisional Appln. Ser. No. 61/513,602 filed on Jul. 31, 2011, entitled “Socially Networked Business & Consumer Space,” which is incorporated by reference herein in its entirety.

### BACKGROUND

In the general consumer space, merchants reach out through advertisements in order convert viewers into customers. The general consumer space is focused on capturing the attention of people in the hopes of converting them into customers. Interactions that exist between members of this space may include business-to-consumer interactions, business-to-business interactions, consumer-to-consumer interactions, and consumer-to-business interactions. Business-to-consumer interactions generally include traditional retailing from an established merchant to a member of the consuming public. Business-to-business interactions include sales between two businesses in which one is acting as the seller and the other as the buyer. Consumer-to-consumer interactions generally include transactions between two consumers such as the sale of secondhand goods or a trade. Consumer-to-business interactions are relatively few compared to the other types of interactions in the space and included things like blogs or Internet forums where consumers may provide comments, advice, criticism, etc. about businesses.

The interactions in this consumer space are typically one-way connections in which one party provides something to another party without any type of a feedback loop or social linkage. The activities of businesses primarily try to capture the attention of potential buyers through advertisements. The targets of these advertisements may find them unwelcome and even annoying. Conversely, communications from consumers to businesses, such as blogs, may be ignored or inaccessible to decision makers at businesses. Thus, the current consumer space contains multiple one-way connections, but fails to create a healthy social network that captures and utilizes the intentional, directed creativity and knowledge of participants in the business and consumer space.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 is an example architecture that shows interconnectivity between a consumer, a business, and server computers that facilitate a social space for interaction between businesses and consumers.

FIG. 2 is a block diagram of example components of the server computers of FIG. 1.

FIG. 3 shows example contents of the data stores containing consumer accounts and business accounts from FIG. 1.

FIG. 4 is a flow diagram of an example process for determining a personal price for a consumer based on a knowledge contribution of the consumer.

FIG. 5 is a flow diagram of an example process for determining an incentive for a business to provide to the consumer based on a knowledge contribution of the consumer.

FIG. 6 is an example user interface of a mobile device showing a screen for capturing a knowledge contribution about an item.

FIG. 7 is a flow diagram of an example process for acquiring a knowledge contribution from a consumer.

FIG. 8 is an example user interface of a computing device displaying an electronic magazine that contains knowledge contributions from consumers.

FIG. 9 is a flow diagram of an example process for displaying knowledge contributions of interest to a consumer in an order that is preferred by the consumer.

FIG. 10 is a flow diagram of an example process for rendering pages showing knowledge contributions of interest to a consumer and providing an online purchasing page.

FIG. 11 is an example architecture showing an intermediary account system that processes coupons and rebates transacted between a consumer and a merchant.

FIG. 12 is a flow diagram of an example process for modifying the cost of a purchase by using a rebate.

FIG. 13 is a flow diagram of an example process for provisioning an incentive to a consumer by using a coupon.

FIG. 14 is a flow diagram of an example process for adjusting the score of a consumer based on the consumer scanning a tag with a mobile device.

FIG. 15 is a flow diagram of an example process for providing an offer to sell an item to a consumer when the consumer scans a tag marking the item.

### DETAILED DESCRIPTION

This disclosure describes, in part, a socially networked business and consumer space. Within this social space consumers can interact with one another and with businesses. The consumers may purchase items from the businesses, review the businesses and/or various items sold by the business, interact with advertisements, consume content produced by other consumers, redeem coupons or rebates at the businesses, purchase items using a mobile device, and other activities.

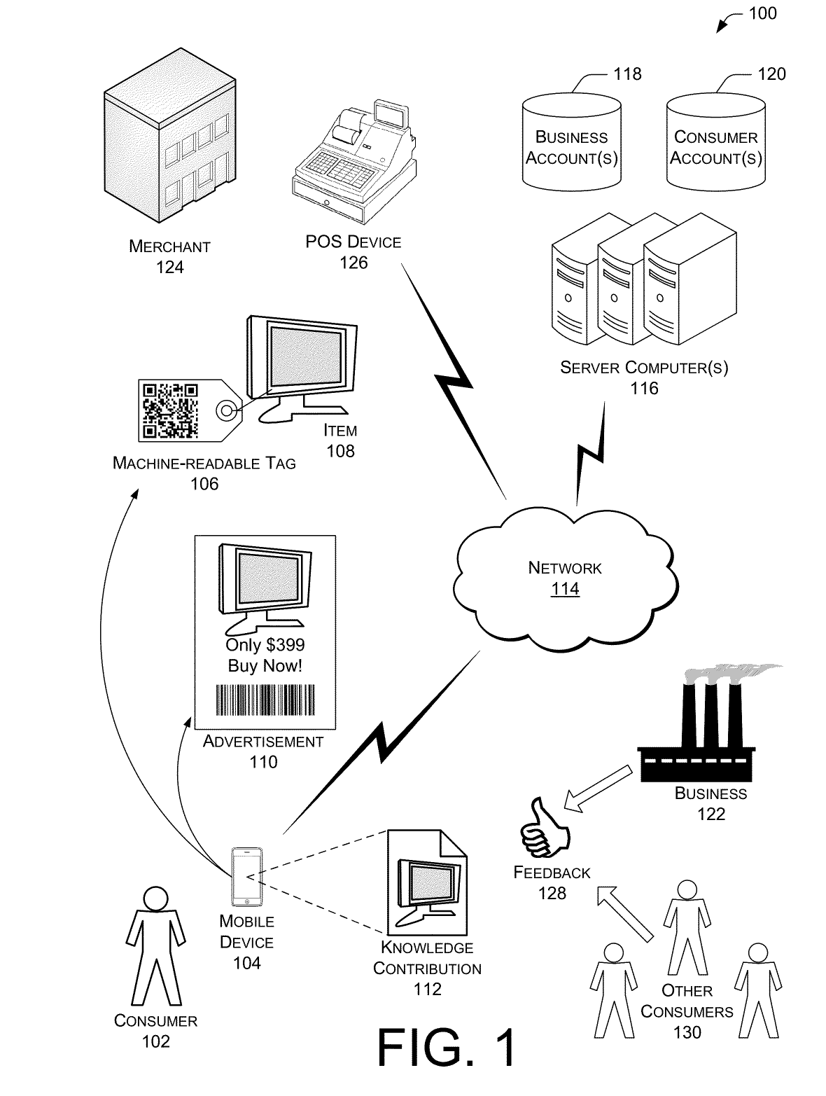

FIG. 1 is a schematic diagram of an illustrative architecture 100 that includes a consumer 102 and a mobile device 104 of the consumer 102. The mobile device 104 may be a mobile phone, a notebook computer, a netbook, a tablet computer, a personal digital assistant (PDA), an e-book reader, a digital media player, a personal gaming device, and the like. The mobile device 104 may be used by the consumer 102 to scan a machine-readable tag 106 attached to an item 108. The tag 106 may include any type of machine-readable mechanism for representing information such as, a one, two, or three-dimensional bar code, a matrix barcode (e.g., quick response (QR) Code®), a radio frequency identification (RFID) tag, a near field communication (NFC) tag, and the like. The tag 106 may encode information representing the item 108 such as a product number for the item 108. As used herein, “item” refers to any type of good or service that may be sold or transacted including digital goods, virtual goods, software as a service, and combinations of goods and services.

The mobile device 104 may read the tag 106 by using a camera to take a picture of the tag 106 that is analyzed by software loaded on the mobile device 104 to extract information from the tag 106. Other types of tags may be read by appropriate components in the mobile device 104 such as an antenna that receives a signal from an NFC target.

A tag may also be placed on an advertisement 110 as well as on an actual item 108. The advertisement 110 may be printed matter such as a poster, catalog, postcard, etc. The advertisement 110 may also be displayed on the electronic display device such as a monitor or television. A tag included on an advertisement 110 may encode information about the advertiser, the item or items promoted in the advertisement 110, the location which the advertisement 110 is posted, or the like.

As the consumer 102 interacts with items 108, advertisements 110, and otherwise participates in the consumer and business space, the consumer 102 may create one or more knowledge contributions 112. The knowledge contributions can be product reviews, comparisons of similar items, how-to guides, product critiques with feature or new design suggestions, and the like. Knowledge contributions 112 can be created by using the mobile device 104 or another computing device such as a desktop computer. The consumer 102 may create multiple knowledge contributions 112 about a single item as well as knowledge contributions about many different items. Each knowledge contribution 112 may be a review of an item, a discussion of the item's functionality, an explanation of how to use the item, a rating of the item, or the like. Knowledge contribution 112 may be presented as any type of digital data such as text, an audio file, a video file, or the like. For example, the consumer 102 may type a review of an item and create a knowledge contribution 112 in text form. Alternatively, the consumer 102 may create a recording of his or her voice describing some aspects of an item and that recording may be the knowledge contribution 112. Similarly, the consumer 102 may make a video about how to assemble an item and share that video as a knowledge contribution 112. It is noted that to make a knowledge contribution 112, the consumer 102 may log onto a dedicated website providing links to a variety of products to be reviewed or commented on. The consumer 102 may or may not be directed to the dedicated website by first interacting with items 108 or advertisements 110.

The knowledge contributions 112 may be shared with others via a network 114. The consumers can access and view these knowledge contributions in order to gain the benefit of the knowledge from fellow consumers and to provide feedback on the knowledge contributions themselves. The mobile device 104 may be connected to the network 114. The network 114 represents any type of communications network such as the Internet, a wide area network (WAN), a local area network (LAN), a telephone network, a cable network, a mesh network, a peer-to-peer network, and the like.

One or more server computers 116 may also be connected to the network 114 and communicate with the mobile device 104 through the network 114. The server computers 116 may include one or more separate hardware devices or a distributed system of multiple pieces of computer hardware that provides the functionality of a server computer through a cloud computing implementation. The server computers 116 may support the socially networked business and consumer space by facilitating communication between various computing devices of the consumers and businesses. In some implementations, the server computers 116 may contain or otherwise have access to one or more business accounts 118 and one or more consumer accounts 120. The business accounts 118 may include an account record for a business 122 that manufactures or is otherwise associated with the item 108. The business 122 may use its business account 118 to participate in the socially networked space by doing such things as reviewing knowledge contributions 112 of the consumer 102. The consumer 102 may have an account record in the consumer accounts 120 that contains information about the consumer 102 such as, for example, each of the consumer's knowledge contributions 112.

A merchant 124 is used herein as an entity that provides the item 108 for sale to the consumer 102. The merchant 124 may also be called a retailer or retail-outlet. Some merchants 124 operate brick-and-mortar sores and may use a point-of-sale (POS) device 126 to process transactions with the consumer 102. In some implementations, the POS device 126 may be connected to the network 114. Thus, the POS device 126 may receive information from the server computers 116 based on data in the business accounts 118 and/or the consumer accounts 120. Information received by the POS device 126 from the server computers 116 may be used to modify a transaction between the merchant 124 and the consumer 102.

In other implementations the merchant 124 may be an online merchant and the computers used to implement the e-commerce storefront for the merchant 124 may communicate with the sever computers 116 over the network 114.

The consumer 102 may be incentivized to provide the knowledge contribution 112 by receiving a monetary benefit from the business 122. By acting as a product reviewer or tester, the consumer may be thought of as a micro-employee of a business which designs, makes, markets, distributes, or retails the product reviewed by the consumer. The business may or may not be a merchant that retails the product. The incentive could be in the form of a cash payment, a coupon, a rebate, or the like. In some implementations, consumers are scored by the business and each consumer receives personal pricing or a personal incentive to effectuate personal pricing for items sold by the merchant. Each consumer may receive his or her own price based on their respective scores. The price for the same item may be different for different consumers based on the respective quality and quantity of knowledge contributions. Thus, personal pricing can provide compensation commensurate with participation in the social community thereby incentivizing the creation of valuable knowledge contributions.

The personal pricing may be based on feedback 128 received on the consumer's knowledge contributions 112. The feedback 128 may include a review or rating of the knowledge contribution 112 that indicates what a business 128 or other consumers 130 thought of the knowledge contribution 112. Consumers that provide high-quality and well reviewed knowledge contributions may receive more favorable personal pricing that the consumers that only provide superficial knowledge contributions. The business 128 that provides the feedback 128 may be the business 128 that manufactures, markets, distributes, promotes, or is otherwise connected with the item 108 that is the subject of the knowledge contribution 112. Thus, the business 128 may review the review of its product. In some implementations, the business 128 may be the same as the merchant 124. In other implementations, the business 128 may be a manufacturer of the item 108 and the merchant 124 may be the brick-and-mortar or online retailer.

The other consumers 130 may be members of the socially networked space and some or all of them may have respective consumer accounts 120. By providing feedback on each other's knowledge contributions 112 the various consumers in this social network strengthen their ties to one another and can develop trust relationships and productive collaborations. Since the merchants 122 and businesses 128 are also part of this network, and there is two-way communication between consumers and merchants. The businesses 128 and merchants 122 also become part of the social network and foster productive interactions with the consumers.

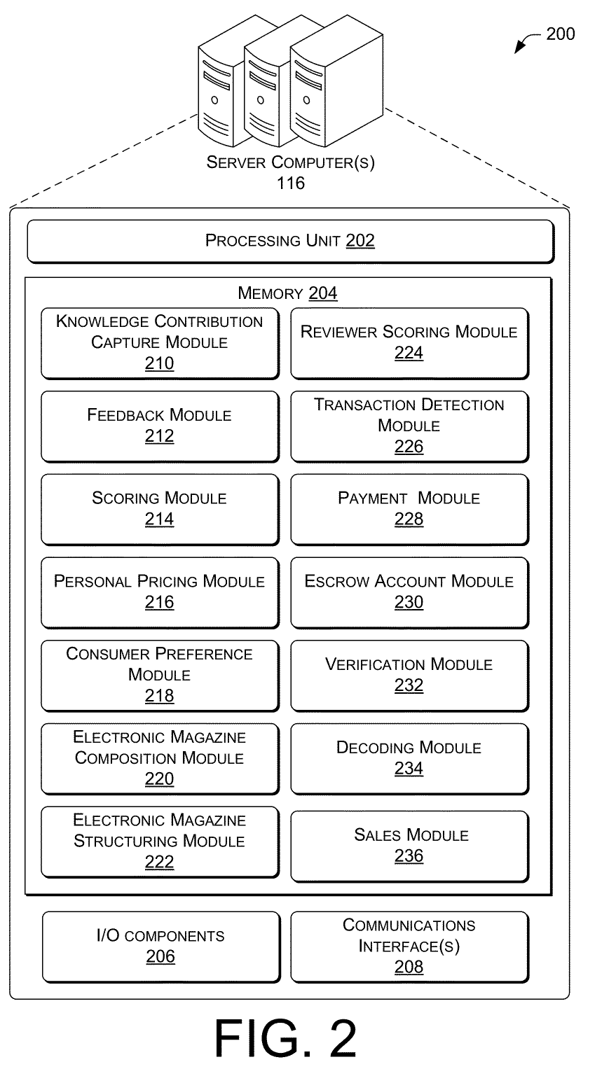

FIG. 2 is a schematic representation 200 showing example components of the server computers 116 introduced in FIG. 1. The server computers 116 may include a processing unit 202. The processing unit 202 represents one or more hardware processors each implemented with a single or multiple core design. Thus, the processing unit 202 may be implemented as a plurality of separate processors that function together as a unit to process instructions. The server computers 116 also include memory 204. In some implementations, the memory 204 may be implemented in hardware or firmware. The memory 204 may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a processing unit. The memory 204 encompasses computer-readable storage media which is non-transitory media that is capable of storing information such as computer instructions in formats other than transitory signals. The memory 204 may contain an operating system for controlling modules within the memory 204 as well as hardware of the server computers 116.

Input and output (I/O) components 206 are one type of hardware that may be a part of the server computers 116. The I/O components 206 may include such things as monitors, keyboards, mice, speakers, printers, and the like. The server computers 116 may also include one or more communication interfaces 208 for receiving and sending information. The communication interfaces 208 may communicatively couple the server computers 116 to a communications network, such as network 114, using any conventional networking protocol or technology.

The memory 204 includes multiple modules such as, but not limited to, a knowledge contribution capture module 210, a feedback module 212, a scoring module 214, a personal pricing module 216, a consumer preference module 218, an electronic magazine composition module 220, an electronic magazine structuring module 222, a reviewer scoring module 224, a transaction detection module 226, a payment module 228, an escrow account module 230, a verification module 232, a decoding module 234, and a sales module 236. Each of these modules will be described in greater detail below. The server computers 116 may also include additional modules within the memory 204 and/or hardware components other than those described herein.

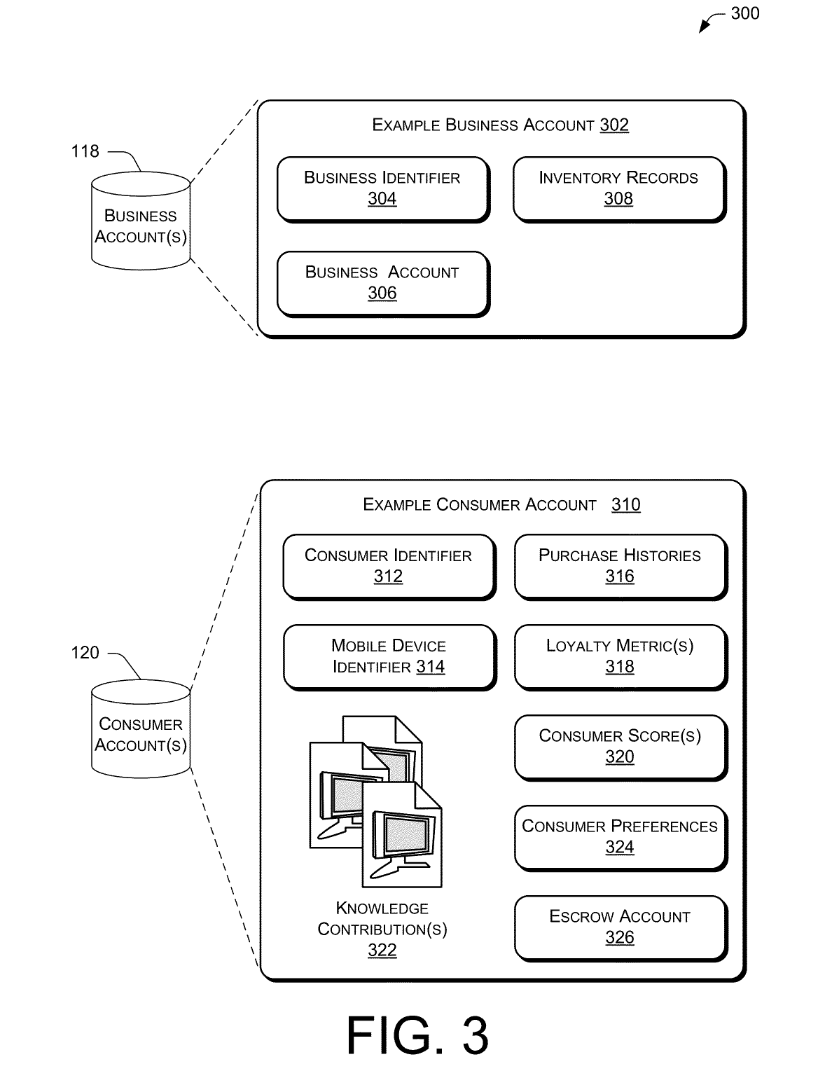

FIG. 3 shows example contents of the business accounts 118 and the consumer accounts 120. The server computers 116 may contain or be connected to a data store that includes the plurality of business accounts 118. An example business account 302 may include a business identifier 304 that uniquely identifies and differentiates one particular business from other businesses participating in this social space. The business identifier 304 may be a name of the business, a numerical or alphanumerical code assigned to the business, or any other type of unique identifier. A business account 306 in the example business account 302 may pay out funds to a merchant or consumer as compensation for a coupon or rebate. The example business account 302 may also include inventory records 308 showing which items are associated with the business. The inventory records 308 may identify items that are available for sale from a brick-and-mortar location as well as items that are available to be shipped to a consumer either directly from the business or from another merchant. The inventory records 308 may include an inventory of items associated with respective item identifiers.

The consumer accounts 120 may also be stored in a data store that is part of or connected to the server computers 116. One example consumer account 310 representing an account of the consumer 102 from FIG. 1 is discussed herein. The example consumer account 310 may include a consumer identifier 312. The consumer identifier 312 may be the name of the person who is the consumer or another unique number or code identifying that person. The consumer may be associated with one or more mobile devices and a mobile device identifier 314 for each of those mobile devices may be stored in the consumer account 310. The mobile device identifier 314 may be a phone number, a device serial number, a subscriber identity module (SIM) card number, or other unique identifier of a mobile device. In this example, the mobile device identifier 314 may identify the mobile device 104 introduced in FIG. 1. Storing the mobile device identifier 314 as part of the consumer account 310 allows for identification of the consumer when the corresponding mobile device is used to facilitate a transaction or scan of a tag.

Past purchase histories 316 of the consumer relative to different merchants, business, and brands may be stored in the consumer account 310. One or more loyalty metrics 318 may be derived from the purchase histories 316. The loyalty metrics 318 may be based on a number of items purchased, a total value of items purchased, a temporal frequency of purchases, or any other quantifiable characteristic that may be obtained from the purchase histories 316 and used to determine the relative strength of preference a consumer has for a particular brand, manufacture, business, merchant, etc. A consumer score or scores 320 may also be stored in the example consumer account 310. The consumer scores 320 may be based on feedback received on knowledge contributions made by the consumer. A consumer may have multiple consumer scores 320 each associated with a different item, item category, business, merchant, brand, etc. Thus, a particular consumer score 320 may be narrowly focused to represent that consumer's contribution, knowledge, loyalty, with respect to a particular item or class of items.

The example consumer account 310 may also include knowledge contributions 322 made by the consumer. A consumer may create any number of knowledge contributions 322. Each knowledge contribution 322 may be associated with a particular item, brand, business, merchant, etc. The server computers 116 may make the knowledge contributions 322 of the respective consumers available for searching, viewing, and access by other consumers and businesses. In some implementations, when a knowledge contribution 322 about a particular item is received, that knowledge contribution 322 may be automatically sent to the respective merchant or business associated with the particular item. This way, businesses may readily stay informed of relevant knowledge contributions 322.

Each consumer may not only provide knowledge contributions 322 but also read or view the knowledge contributions made by other consumers. As part of techniques used to surface the most relevant knowledge contributions to the consumer, consumer preferences 324 may be part of the example consumer account 310. The consumer preferences 324 may indicate which types of knowledge contributions interest this particular consumer. For example, the consumer preferences 324 may indicate that the consumer is interested in cooking and knowledge contributions about cooking or items used for cooking. Similarly, the consumer preferences 324 may indicate that consumer has favorite authors (e.g., other consumers) of knowledge contributions. Additionally, the consumer preferences 324 may show that the consumer likes particular brands, particular places, particular categories of items, and the like. Knowledge contributions that discuss those brands, places, etc. may be treated as preferred content for this consumer.

Additionally, the example consumer account 310 may include an escrow account 326 for the consumer. The escrow account 326 for the consumer may receive funds from the business account 306 shortly after the consumer submits a rebate. Money in this escrow account 326 may be released to the consumer once satisfactory confirmation of the transaction and payment has been received.

### Knowledge Contributions and Personal Incentives

This disclosure describes, in part, techniques for incentivizing, capturing, and commercializing productive energy of consumers. When making purchases, consumers spend not only money but also time and resources researching and evaluating the items that they purchase. Consumers that have purchased an item are able to provide information on their experiences and on the quality of the item. However, much of this knowledge is not captured because it stays with the individual consumers and is not shared in a social space where the knowledge can be accessed and used by others.

Consumers may provide knowledge contributions to reflect their respective knowledge and experiences with different items. Businesses may provide personal incentives to encourage the consumers to provide knowledge contributions. Merchants and businesses may also review knowledge contributions to provide feedback to the consumer who made the knowledge contribution. The knowledge contributions and the corresponding reviews about the knowledge contribution creates a feedback loop between consumers, business, and merchants. Thus, consumer-to-business interactions can become a meaningful part of this social network due to the presence of feedback.

Returning to FIG. 2, several modules from the memory 204 of the server computers 116 are of particular relevance to capturing knowledge contributions and determining personal incentives. For example, the knowledge contribution capture module 210 captures a knowledge contribution made by a consumer about an item. The knowledge contribution capture module 210 may receive an indication of an item, such as a unique item identifier, and a knowledge contribution about the item. The knowledge contribution may be any format such as a text file, an audio file, a video file, and the like. The knowledge contribution may be received from, for example, the mobile device 104 of the consumer 102. In some implementations the knowledge contribution, once captured, may be stored in a consumer account as shown in FIG. 3.

The feedback module 212 may receive feedback on the knowledge contribution. The feedback may be received from a business, a merchant, or peer feedback from one or more other consumers. Multiple feedbacks may be received from multiple sources and ratings or other metrics may be computed across all of the different sources of feedback. Thus, a given knowledge contribution may have a score or a rank derived from the feedback provided by a plurality of sources. In some implementations, the businesses which provide feedback may be limited to only those businesses or merchants that are associated with the item discussed in the knowledge contribution. Thus, the business providing feedback may be a business or merchant that designs, makes, markets, distributes, or retails the item.

The scoring module 214 may quantify a score for the consumer based on past actions of the consumer. The past actions may include actions that represent loyalty or preference for a particular brand or manufacturer of items. In such instances, the scoring module 214 may generate a loyalty metric for the consumer based on a purchase history of the consumer. The loyalty metric may be store in a consumer account of the consumer as shown in FIG. 3.

The past actions may also include generation of knowledge contributions. In some implementations, the score may be based simply on a number of knowledge contributions. In other implementations, the score for the consumer may be based on the feedback received for that consumer's knowledge contributions. Thus, positive feedback for knowledge contributions may result in an improved score as compared to no feedback or negative feedback. The scoring module 214 may quantify the score for the consumer based any one or combination of feedback from businesses, the peer feedback from other consumers, and the loyalty metric of the consumer.

The personal pricing module 216 may calculate a personal incentive for the consumer on an item sold by a business. The personal incentive may be specific to the consumer. In some implementations the personal incentive is a function of the consumer's score as determined by the scoring module 214. For example, a higher score may lead to a more valuable personal incentive. The personal incentive may be a personal price that can be achieved by subtracting a discount amount from on a base price of the item. The personal price may be provided to the consumer by giving the consumer a credit or a rebate to reimburse the consumer for paying a higher price than the personal price. In other implementations, the personal pricing may be achieved by providing the consumer with a coupon that can be used to reduce the purchase price of the item at the time the consumer purchases the item.

As well as being consumer specific, the personal pricing may also be item specific. For example, a consumer that has provided a large number of knowledge contributions related to an item that belongs to a particular item category may receive low personal prices for other items in the same item category. However, the consumer may not receive any discount for items in different categories for which he or she has not provided knowledge contributions.

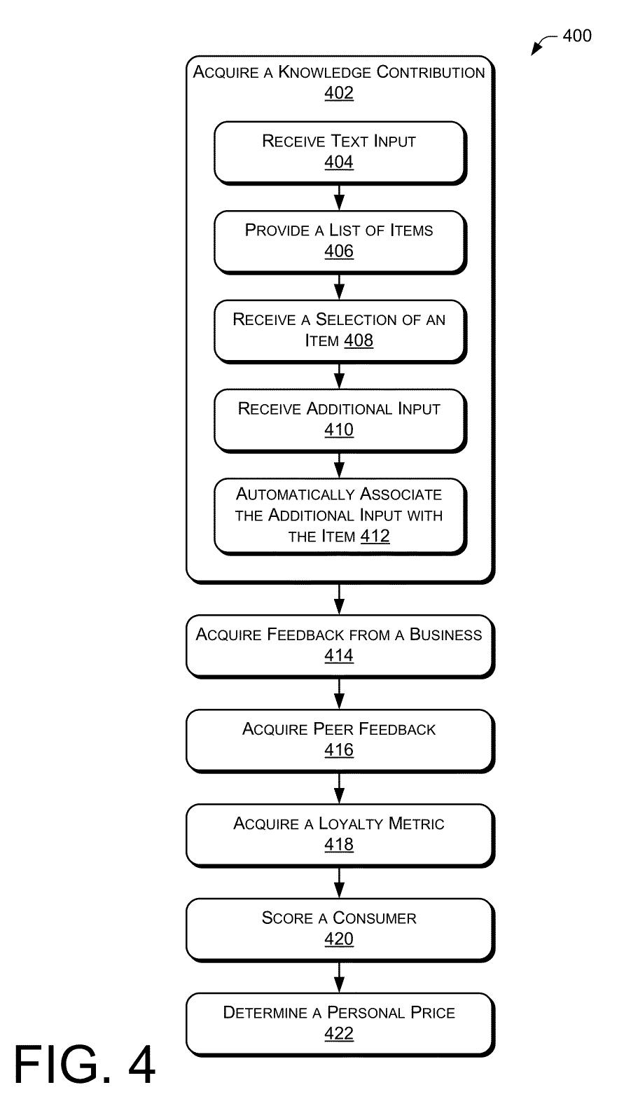

FIG. 4 shows an example process 400 for determining a personal price for a consumer. At 402, a knowledge contribution about an item is acquired. The knowledge contribution is made by the consumer. The knowledge contribution may be a review, a rating, a comment, or a recommendation about the item. Acquiring the knowledge contribution may include receiving the knowledge contribution from the consumer and storing the knowledge contribution in association with both an identifier of the consumer an identifier of the item. The identifier of the consumer may be the consumer identifier 312 shown in FIG. 3. The identifier of the item may be a global unique product identifier. In some implementations, the identifier of the item is obtained when the consumer scans a machine-readable tag with a mobile device.

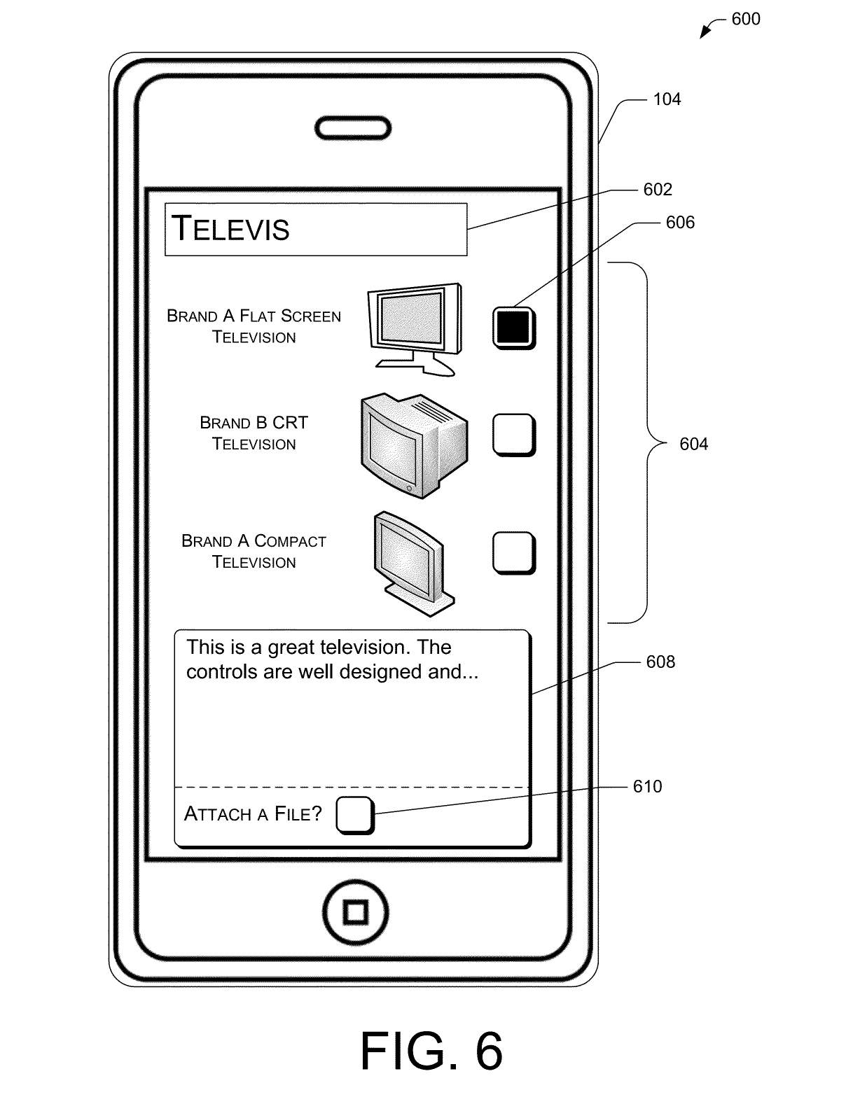

The knowledge contribution may be made by the consumer taking a photograph, recording a video, or otherwise using a computing device to submit information. In some implementations, the knowledge contribution may be acquired by the consumer entering text into a user interface designed to capture knowledge contributions. An example user interface is shown in FIG. 6.

At 404, text input may be received from the consumer. The text input may be provided by the consumer typing on a mobile computing device.

At 406, a list of items may be provided to the consumer based on the text input. For example, the list may include items that match the text input. Thus, the consumer may effectively search a database of items and receive a list of “hits” that show matching items.

At 408, a selection by the consumer of an item from the list of items is received. The selection may be generated by any technique such as the consumer selecting a check box next to the item, clicking or double clicking on the item, touching a touch-screen display, or the like.

At 410, additional input is received from the consumer. The additional input may be a knowledge contribution relate to the item. This provides the consumer with an efficient way to find the correct “place” to enter his or her knowledge contribution.

At 412, the additional input is automatically associated with the item. The automatic association may include storing the additional input in association with an item identifier of the item.

At 414, feedback is received from a business. The business may be the business that sells, distributes, manufactures, or is otherwise associated with the item. The feedback may be a review, rating, ranking, or the like of the knowledge contribution. For example, the feedback may be a positive, neutral, or negative indicator. Alternatively, the feedback may be a numerical rating such as from one to five (e.g., stars), 0-10, or the like. The feedback by the business may be given manually, or given by an automatic algorithm which may be either generic to multiple businesses or specific to a certain business. Furthermore, separate feedback by the business is optional because any business feedback may be made a part of the scoring mechanism and/or the personal pricing mechanism disclosed herein.

At 416, peer feedback is received. The peer feedback may be feedback from other consumers. Receiving both feedback from business and peer feedback may help quantify different aspects of the knowledge contribution. For example, the businesses may provide feedback based on how positive or complementary the knowledge contribution is towards the item. However, other consumers may provide feedback based on how accurate or useful the knowledge contribution is for making a purchasing decision.

At 418, a loyalty metric is received. The loyalty metric is associated with the consumer and the business and represents the loyalty of the consumer towards the business. The loyalty metric may be stored in the account of the consumer as shown in FIG. 3. The loyalty metric may be based on the purchase history of the consumer such as the frequency, quantity, and value of past purchases made by the consumer from the business. The purchase history that is used to derive the loyalty metric may be obtained from the consumer account 310 shown in FIG. 3.

At 420, the consumer is scored. The scoring of the consumer may be performed by the scoring module 214 shown in FIG. 2. The scoring is not a general score for the consumer, but rather is a score that is specific to a category of knowledge contributions associated with the item. On the other hand, the scoring is not required to be specific to a particular item. For example, the item may be associated with a particular brand, business, merchant, class or items, category or items, or the like and the knowledge contribution will have a similar association. Thus, a knowledge contribution that is a review of a DVD player of brand W, may be associated with DVD players, home electronics, and/or brand W. The scoring may be based on any or all of the feedback received from the business at 414, the peer feedback received at 416, and the loyalty metric at 418. Each or the respective sources for calculating the score may receive different weighting. The same contributing consumer may also earn scores from other brands. As a result, in some embodiments, each contributing consumer has a matrix of personal scores.

At 422, a personal price is determined for the consumer for the item or a related item. The related item may be a similar item, a newer model of the item, an accessory that can be used together with the item, another item of the same brand, another item from the same business, or the like. The personalized price may be based on the score determined at 420. A higher or better score may correlate with a lower, or better, personalized price. Thus, consumers are incentivized to earn higher scores in order to receive greater discounts. The personalized price may be based on a base price of the item (e.g., a price that a consumer who is not a member of this social network would pay) and a discount amount. The discount amount may be a fixed amount such as $10 or a relative amount such as 10% of the base price.

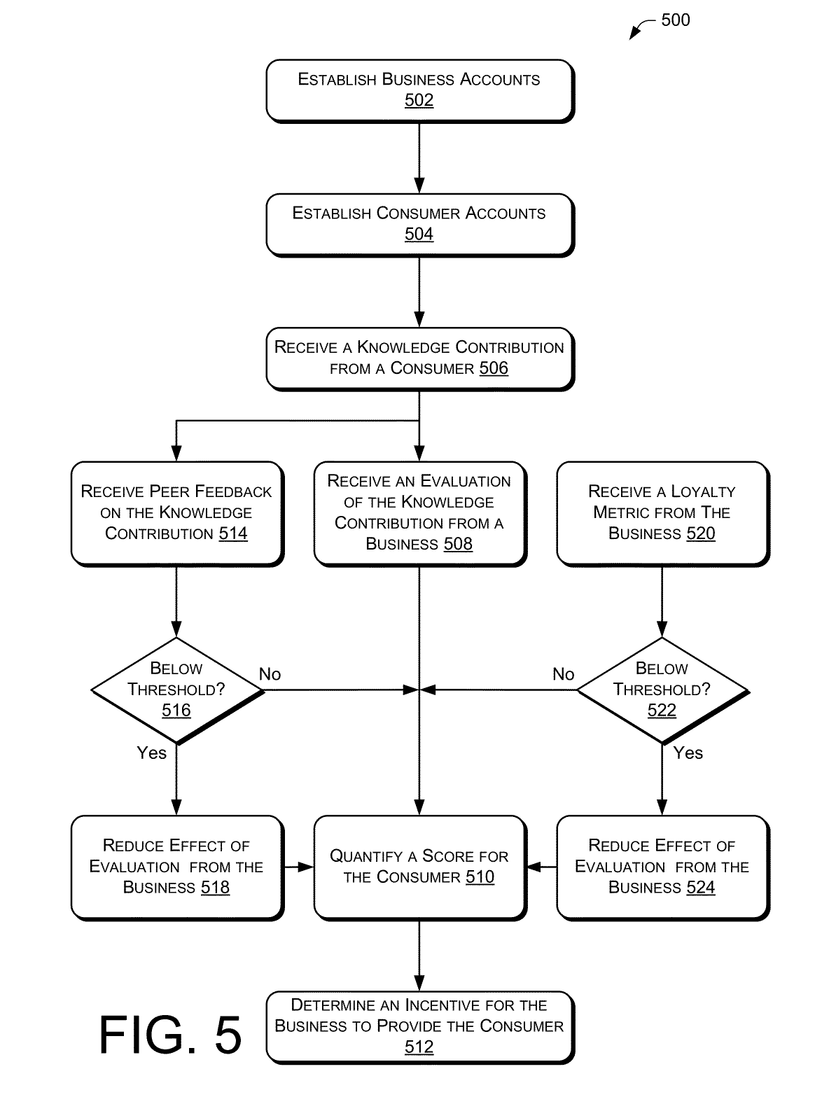

FIG. 5 shows an example process 500 for determining an incentive to provide a consumer. At 502, multiple business accounts are established for multiple businesses. Each of the multiple businesses may sell items to one or more consumers. The business accounts may be the same or similar to the business accounts 118 shown in FIG. 3.

At 504, multiple consumer accounts are established for multiple consumers. The consumer accounts may be the same or similar to the consumer accounts 120 shown in FIG. 3.

At 506, a knowledge contribution about an item made or sold by a business is received from a consumer. The consumer may be one of the consumers for whom an account was established at 504. The business may be one of the businesses that had an account established at 502. The knowledge contribution may be received by the knowledge contribution capture module 210.

At 508, an evaluation of the knowledge contribution received at 506 is received from the business. The business may use its own subjective or objective criteria to evaluate the knowledge contribution. For example, the business may evaluate the knowledge contribution based on how much the business believes that the knowledge contribution contributes to the business model of the business. The evaluation from the business may be received by the feedback module 212. The feedback by the business may be given manually. Alternatively the feedback may be given by an automatic algorithm which uses peer feedback or other metrics as an input for evaluation of the knowledge contribution. Such automatic algorithm may be either generic to multiple businesses or specific to a certain business. Furthermore, it should be noted that separate feedback by the business at 508 is optional, because any business feedback may be made a part of the scoring mechanism and/or the personal pricing mechanism disclosed herein.

At 510, a score is quantified for the consumer. The score may be based on the evaluation of the knowledge contribution provide by the business at 508. Quantification of the score may include modifying a raw score provided by the business or converting a non-numerical evaluation into a numerical score. The quantifying of the score may be performed by the scoring module 214.

At 512, an incentive is determined for the business to provide the consumer based on the score quantified at 510. Generally, the incentive may be more valuable the greater the score of the consumer. However, there may be instances in which lesser (or lower) scores earn a consumer a more valuable incentive. For example, to encourage consumers to make an initial knowledge contribution, there may be a relatively valuable incentive provided for low scores.

In addition to receiving an evaluation from the business at 508, an evaluation of the knowledge contribution may also be received as peer feedback from other consumers at 514. The peer feedback may also be received by the feedback module 212. The other consumers may provide feedback based on how useful they find the knowledge contribution. In some implementations, the best or highest scoring knowledge contribution as evaluated by peer feedback in a category may receive a special status such as the “best answer.” The consumer who provided that knowledge contribution may also receive special status such as a “guru” or subject matter expert.

In some cases the feedback received from other consumers may be very different from feedback received from the business at 508. For example, a critical review of an item that is well written and provides useful information to other consumers may receive positive peer feedback at 514. However, because the review is not complementary of the business' item, the business may provide negative feedback at 508. In some implementations, business feedback and peer feedback may be tactically balanced by different weighting. Too much deference given to business feedback may result in less trustworthy product reviews. On the other hand, the business may have a legitimate reason to reward a knowledge contribution (such as the constructive critic) regardless of the popularity of the knowledge contribution. The business and consumer space disclosed herein may aim to capture the productivity of consumers as micro-employees of various businesses, rather than as product promoters which is the only significant goal of the existing systems.

At 516, it is determined if the peer feedback received at 514 is below a threshold level. If the feedback is not below the threshold level (i.e., the other consumers provide at least a threshold level of positive feedback) process 500 proceeds along the “no” path and proceeds as described above. If, however, the peer feedback is below the threshold level process 500 proceeds along the “yes” path to 518.

At 518, the effect of the evaluation received from the business at 508 is reduced. This may reduce the benefit consumers receive from superficially complementary knowledge contributions. For example, a knowledge contribution simply praising an item made by the business without providing any useful knowledge may receive a highly positive review from the business (because the knowledge contribution was complementary) but may receive a low review from other consumers (because the knowledge contribution does not include specific, useful information). Reducing the effect of the evaluation received from the business may change the score quantified for the consumer at 510.

In addition to reviews (by other consumers and business) a consumer may have a loyalty metric with respect to a particular business. The loyalty metric (or metrics for different levels of loyalty for different business) may be stored in a consumer account as shown in FIG. 3. At 520, a loyalty metric may be received from the business. The loyalty metric may be based on a purchase history of the consumer. For example, if the consumer frequently buys products from the business and rarely buys products for competing business, then the consumer may have a high loyalty metric. The loyalty metric may be wholly independent of the evaluations provided for the consumer's knowledge contributions.

At 522, it is determined if the loyalty metric is below a threshold level. If the loyalty metric is at or above the threshold level, process 500 proceeds along the “no” path and continues as described above. If the loyalty metric is below the threshold level (e.g., the consumer is not particularly loyal to this business) process 500 proceeds along the “yes” path to 524.

At 524, the effect of the evaluation from the business of the knowledge contribution received at 508 is reduced. Reducing the effect of the feedback received from the business affects the quantification of the score for the consumer at 510. For example, a consumer that is not loyal to the business may receive a lower score at 510 than he or she would receive otherwise.

The incentive determined at 512 may be a personalized price, a discount, a rebate, a coupon, or a credit for an item sold by the business. Accordingly, the business may desire a system that provides the greatest incentives and best “rewards” to the best consumers. Accordingly, reducing the score at 524 for consumes that have a low level of loyalty may support the business' goals. However, the business may also wish to foster a business and consumer social space in which productive energy is rewarded. Therefore, the business may recognize the value of knowledge contributions that help other consumers. Thus, knowledge contributions which receive poor peer feedback may have reduced their effect on a consumer's score reduced at 518. Both considerations may be combined and the quantification of a score for the consumer at 510 may depend on all three of the peer feedback from 514, the evaluation from the business at 508, and the loyalty metric at 520.

FIG. 6 shows an example user interface 600 for capturing a knowledge contribution. Even consumers that are interested in being productive members of this business and consumer social space may be discouraged from creating knowledge contributions if it is difficult to participate. User interfaces that allow the consumers to quickly locate the item that is the subject of a knowledge contribution and provide an easy way to upload the content of the knowledge contribution will help support a healthy social space. This user interface 600 may be presented on the mobile device 104 introduced in FIG. 1 or on any other computing device such as a desktop computer. The interface 600 may include a search field 602 for entering text in order to locate the item that the consumer wishes to associate with his or her knowledge contribution. The search field 602 may perform an instant search as the consumer types text into the search field 602. The instant search may be performed on a character-by-character basis. This may provide the consumer with feedback faster than a searching technique in which the consumer must completely enter a search term before receiving any results.

The user interface 600 may also present a list 604 of items that match the search query. In this example, the consumer wishes to generate a knowledge contribution about a television and the results shown in the list 604 include three different televisions. When the list 604 includes the item for which the consumer wishes to generate a knowledge contribution, the user interface may provide a button 606 or other user interface element that allows the consumer to select a specific item from the list 604.

Example user interface 600 shown here includes an input field 608 for entering the knowledge contribution. The input field 608 may be presented on the same page as the search field 602 and the list 604. However, in other implementations the input field 608 may be displayed on a different page subsequent to selection of an item from the list 604. The consumer may enter text in the input field 608 that includes information he or she wishes to provide in the knowledge contribution. In order to receive knowledge contributions in formats other than text (e.g., audio or video) the same user interface 600 may also include a button 610 or other feature indicating that the consumer wishes to attach a file as part of the knowledge contribution. The user interface 600 may display the button 610 for attaching a file within the input field 608 for receiving the knowledge contribution. Thus, a single input field 608 may be configured to receive knowledge contributions formatted as text as well as attached files.

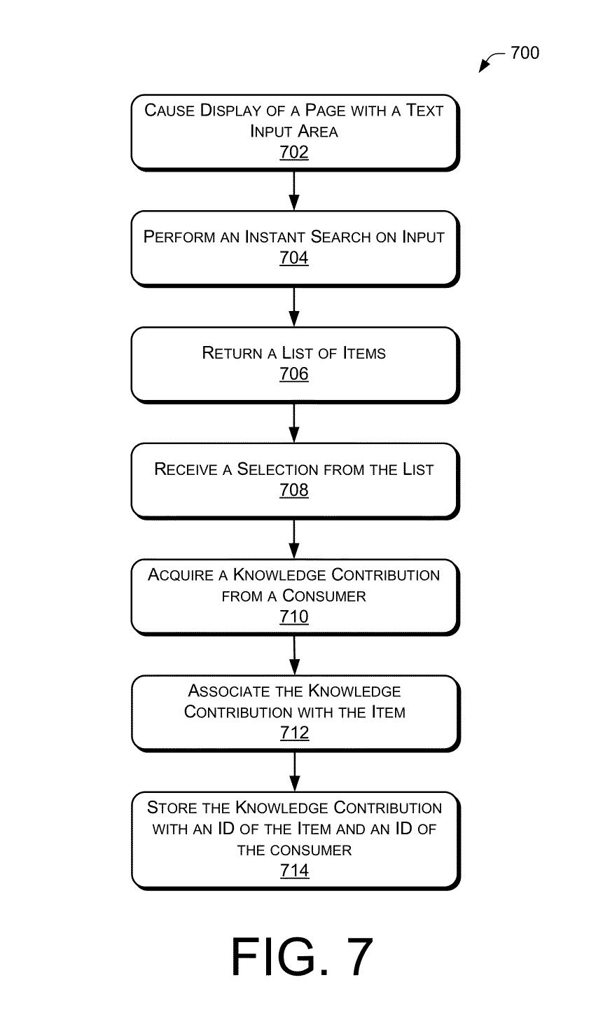

FIG. 7 shows an example process 700 for acquiring a knowledge contribution from a consumer. Process 700 may be implemented with the user interface shown in FIG. 6 or in another user interface. At 702, a system causes the display of a page on a user interface. The page may be a webpage created by a server computer and sent to a mobile device for rendering. The page may also be a screen image created by a local application on a device such as a mobile device of the consumer. The page includes a text input area.

At 704, an instant search using character-by-character searching is performed on text that the consumer enters in the text input area.

At 706, a list of items that matches the entered text input is returned.

At 708, a selection of an item from the list of items is received. The selection may be indicated by the consumer activating a button or other user interface element that is associated with one particular item from the list of items returned at 706.

At 710, a knowledge contribution is received from the consumer via an input field on the page of the user interface. The knowledge contribution may be text data, image data, audio data, video data, or any other format. Input field may be presented on the same page as the list of items and the text input area. The consumer may generate the knowledge contribution following selection of the item from the list of items. For example, the consumer may pick one of the items on the list and then proceed to type comments about the item. In other implementations, the knowledge contribution may be something that was previously created by the consumer and submitted as via the input field. For example a previously recorded video may be submitted as a knowledge contribution to be associated with the item selected from the list. Thus, the input field may receive both knowledge contributions generated as the consumer is interacting with the user interface as well as knowledge contributions that were previously created and are stored as files. In some implementations, the knowledge contributions may include combinations of data types and file types, for example, a knowledge contribution may be an attached image file accompanied by text explaining the image that is typed into the input field.

At 712, the knowledge contribution is automatically associated with the item selected from the list of items. With this process 700, the consumer can easily identify which items he or she wishes to provide a knowledge contribution about and enter that knowledge contribution. Then the system automatically takes a knowledge contribution and associates it with the selected item. Thus, the consumer's knowledge contribution is put in the appropriate “place” in a data store of knowledge contributions.

At 714, the knowledge contribution is stored in association with identifier of the item and the identifier of the consumer. For example, the knowledge contribution may be a record in a database that is tagged with a unique number for the item and another unique number for the consumer. Therefore, future reference to this knowledge contribution can be attributed to the consumer and others looking for knowledge contributions about the particular item can easily locate knowledge contributions stored in this manner.

### Surfacing Preferred Knowledge Contributions

The techniques described above allow for the creation and evaluation of knowledge contributions. Each consumer may value the incentives he or she receives in exchange for contributing knowledge contributions. However, the value of the knowledge contributions is greatest when they are available to a large number of other consumers. In other words, the social fabric of this business and consumer space is strengthened when the productive energy and knowledge of the various consumers can be shared with one another.

The knowledge contributions created by the consumers may be stored in their respective consumer accounts 310 as shown in FIG. 3. Access to the consumer accounts 310 may be mediated by the server computers 116 introduced in FIG. 1. The knowledge contributions may also be made available through an additional or alternative data store of knowledge contributions other than the respective consumer accounts 310.

Consumers may search to find knowledge contributions of interest. Alternatively, the consumers may have knowledge contributions pushed to them in the form of an e-mail digest or similar type of presentation. One technique for surfacing relevant knowledge contributions to consumers is an electronic magazine that presents the knowledge contributions in a visually attractive format which is easy for the consumers to access and also presents the knowledge contributions that are likely to be of greatest interest to a given consumer.

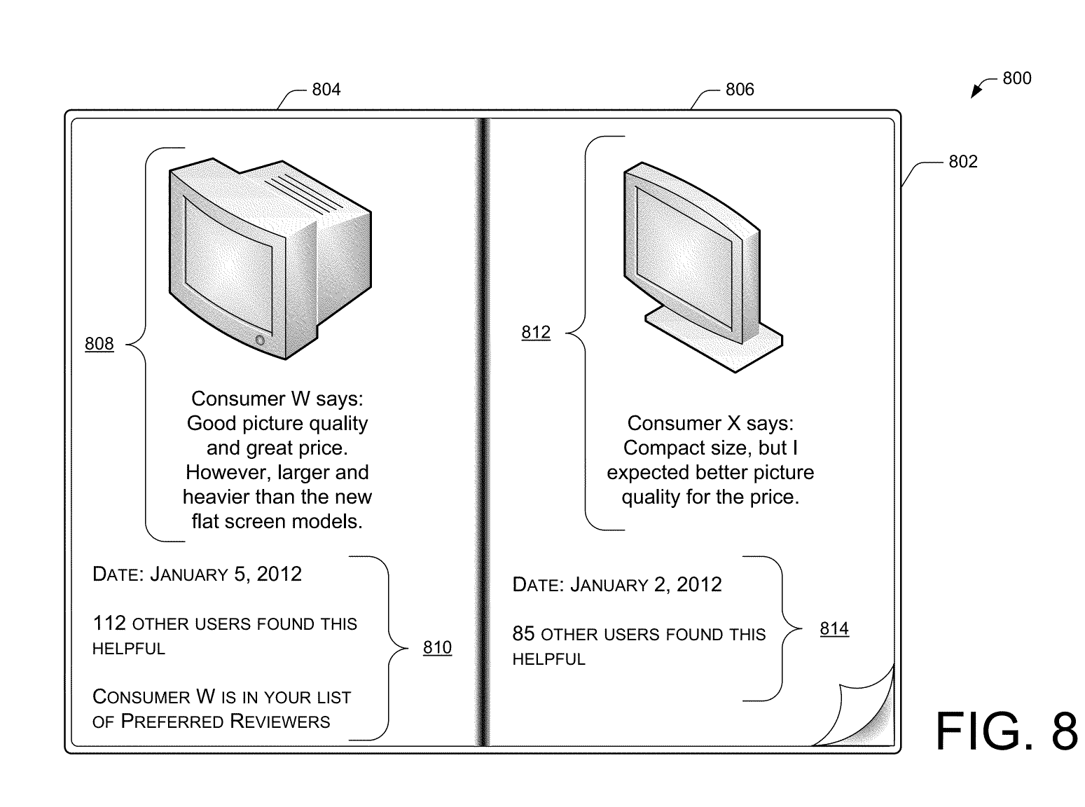

FIG. 8 shows an example user interface 800 that presents an electronic magazine containing knowledge contributions. This view of the user interface 800 shows a computing device 802 that is displaying two pages 804 and 806 of an electronic magazine. Each of the respective pages 804 and 806 may be a visual display of electronic data, such a webpage, an item page, an interface of an application, or the like. The computing device 802 may be a mobile computing device such as the mobile device 104 shown in FIG. 1. Here, the user interface 800 shows the display of the computing device 802 presenting two pages 804 and 806 as a full-screen image. However, the user interface 800 may be configured to display only a single page as a full-screen image.

Each page of the electronic magazine may display one knowledge contribution. For example, page 804 shows a knowledge contribution 808 that identifies the item which is the subject of the knowledge contribution and the substance of the content provided by the consumer. Here, the author of the knowledge contribution is identified as consumer W. The page 804 may also include additional information 810 about the knowledge contribution such as the date the knowledge contribution was received, a number of other users that found the knowledge contribution helpful, an indicator that the author of this knowledge contribution (consumer W) is in a list of preferred reviewers, and the like. The additional information 810 may include other data or metadata about the knowledge contribution 808.

The next page 806 in this electronic magazine contains another knowledge contribution 812 and additional information 814 about that knowledge contribution. As this page 806 is “turned” a page-turn animation may be displayed and this page 806 may replace the position of the previous page 804 so that the next page electronic magazine comes to occupy the portion of the screen currently occupied by the page 806.

Each knowledge contribution 808 and 812 that is included in the electronic magazine may be selected for inclusion based on preferences of the consumer that is receiving the electronic magazine. Thus, each consumer may receive a personalized electronic magazine which includes the knowledge contributions he or she is most likely to find useful or interesting. The ordering of the knowledge contributions within the electronic magazine may also be based on the preferences of the consumer. The electronic magazine may be ordered so that the most preferred knowledge contributions appear earlier in the magazine.

Any number of algorithms may be used to determine which knowledge contribution is more likely to be preferred for a given consumer. The consumer may explicitly indicate his or her interests and preferences such as by providing a list of preferred reviewers, brands, items, etc. of interest. The consumer may also indicate that he or she wishes to consume knowledge contributions preferentially based on dates, the feedback received from other consumers, or any other metric. Consumer preferences 324 may be stored in the consumer account 310 as shown in FIG. 3. For example, the knowledge contribution shown on page 804 may come before the knowledge contribution shown on page 806 because it was created a few days earlier, a greater number of other users found it helpful, and/or because it was written by a preferred reviewer.

Returning to FIG. 2, several modules from the memory 204 are particularly relevant to surfacing and presenting knowledge contributions for consumption by one of the consumers in this social space. The server computers 116 may access a data store of knowledge contributions through the one or more communication interfaces 208. Each of the knowledge contributions in the data store may provide a review, a rating, comment, or a recommendation about an item.

The consumer preference module 218 may learn the preferences of the consumer about which knowledge contributions the consumer wishes to review or otherwise consume. The consumer may have an interest in particular brands and wish to see knowledge contributions related to those brands. There may also be other consumers and create knowledge contributions that are useful and entertaining. Thus, a given consumer may be interested in knowledge contributions based on the items discussed, the brands presented, the author of the knowledge contribution, or other factors. Given the potentially large number of knowledge contributions, consumers may wish to filter or otherwise limit the knowledge contributions that they consume (e.g. read, view, listen to, etc.) such as but only consuming knowledge contributions that receive the most positive feedback (e.g., a rating of eight or above on a ten-point rating scale).

The consumer preference module 218 may implement preferences specifically indicated by the consumer. For example, the consumer may specify that he or she prefers knowledge contributions from reviewers included in a list of preferred reviewers. Similarly, the consumer may also indicate that he or she prefers knowledge contributions about items that are included in a list of preferred items selected by the consumer. Additionally or alternatively, the consumer preference module 218 may also learn the preferences of the consumer based on knowledge contributions that the consumer actively seeks out and reads, items that the consumer purchases, an amount of time the consumer interacts with a page showing a knowledge contribution, or other activities of the consumer that may lead to an inference about the consumer's preferences.

The electronic magazine composition module 220 creates an ordered set of knowledge contributions that includes a preferred subset of the knowledge contributions. Thus, the electronic magazine composition module 220 selects the “most preferred” knowledge contributions to include as pages in the electronic magazine. The selected knowledge contributions are ordered according to a preferred ordering which is based on the preferences of the consumer. Thus, the pages of the magazine are selected and the order of the pages is determined by the electronic magazine composition module 220. As one example, the pages may be ordered chronologically so that the most recent knowledge contributions appear first and the older knowledge contributions appear later. As a further example, the order in which the consumer “flips through” or accesses pages in a previous electronic magazine may be analyzed and used to order the electronic magazine so that the electronic magazine composition module 220 can learn a preferred ordering from the previous reading order of the consumer.

The electronic magazine structuring module 222 communicates the ordered set of knowledge contributions to the client terminal for display as the electronic magazine. The pages of the electronic magazine may be formatted to fit the screen of the target client terminal and converted to an appropriate file type for the client terminal. The electronic magazine may also be structured so that the client terminal renders page-turn animations as the pages of the electronic magazine are changed.

The reviewer scoring module 224 receives input from the consumer when the consumer gives feedback on product knowledge contributions from various reviewers. This feedback may be used as part of calculating a score for the respective reviewers as discussed above. The reviewer scoring module 224 may also quantify a score for the reviewers based on the feedback and use the quantified scores to identify which reviewers are most preferred by the consumer. The electronic magazine composition module 220 may use the scores of the reviewers to identify preferred reviewers and to select knowledge contributions for inclusion in electronic magazines.

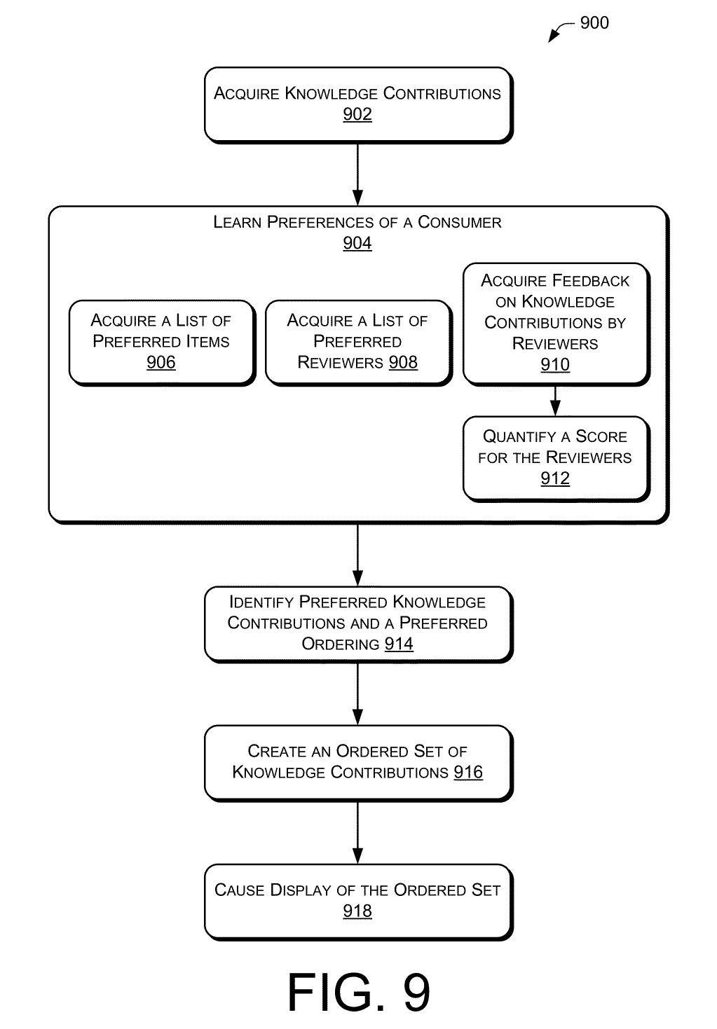

FIG. 9 shows an example process 900 for displaying knowledge contributions based on the preferences of a consumer. At 902, multiple knowledge contributions are acquired. Each of the knowledge contributions may provide a review, a rating, a comment, or a recommendation about an item. Each of the knowledge contributions is generated by a reviewer and a single reviewer may generate more than one knowledge contribution.

At 904, preferences of the consumer about which knowledge contributions the consumer wishes to consume are learned. The preferences may include a greater preference for recent knowledge contributions over old knowledge contributions.

At 906, a list of preferred item selected by the consumer is acquired and the preferences may then include a greater preference for knowledge contributions about items in the list as compared to knowledge contributions about items not in the list.

At 908, a list of preferred reviewers is acquired from the consumer. Learning the preferences of the consumer may then include recognizing a greater preference for knowledge contributions from reviewers who are included in the list of preferred reviewers over knowledge contributions from reviewers who are not in the list.

At 910, feedback from the consumer is acquired about the knowledge contributions. Given that each knowledge contribution is associated with a reviewer that generated the knowledge contribution, the feedback provided about knowledge contributions may be used to quantify score for the reviewers. Thus, even if the consumer is not paying attention to which reviewer generated each specific knowledge contribution, by providing feedback about the content of the knowledge contributions the consumer may allow the system to infer which reviewers are preferred by the consumer.

At 912, the score is quantified for some or all of the reviewers. Reviewers who earn a high score based on their knowledge contributions may receive greater preference than reviewers having a low score. For example, if the consumer repeatedly gives positive feedback on knowledge contributions by consumer W, then a new knowledge contribution by consumer W (which the consumer has yet to read or review) might be given preferential positioning in the electronic magazine. The score quantified at 912 is specific to the consumer receiving the electronic magazine. Accordingly, a reviewer who is well thought of by this consumer (e.g., consumer W acting as a reviewer) may not be a preferred reviewer for a different consumer.

At 914, a preferred subset of the knowledge contributions is identified and a preferred ordering for that subset is also identified based on the preferences learned at 904-912.

At 916, an ordered set of knowledge contributions that includes the preferred knowledge contributions ordered according to the preferred ordering is created. This ordered set of knowledge contributions may be the electronic magazine or it may be the data that is later formatted into an electronic magazine. For example, once a subset of knowledge contributions is identified and an ordering is determined, the content represented by those knowledge contributions may be formatted in different ways as appropriate for a particular target device. Thus, the content and the order may be one degree abstracted from the electronic magazine itself.

At 918, a computing device is given instructions which cause it to display the ordered set of knowledge contributions to the consumer. Display of the ordered set of knowledge contributions (i.e., the electronic magazine) may be triggered by the consumer accessing a data store that contains some or all of the knowledge contributions. For example, when the consumer directs the computing device to a webpage that provides a link to the data store of knowledge contributions, the consumer may initially be presented with his or her customized electronic magazine. This may provide a more convenient and enjoyable way to access the knowledge contributions rather than searching through a database. However, if the consumer wishes to find knowledge contributions about a specific item then consumer may search through the data store of knowledge contributions using any conventional technique. The computing device that displays the ordered set of knowledge contributions may be a handheld, wireless computing device such as the mobile device 104 introduced in FIG. 1.

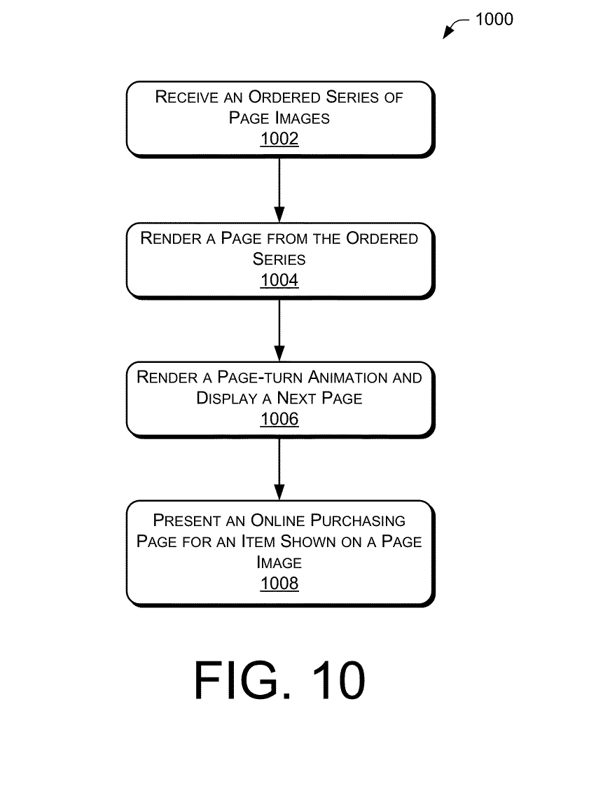

FIG. 10 shows an example process 1000 for rendering an electronic magazine on a mobile computing device. The mobile computing device may be the mobile device 104 shown in FIG. 1, the computing device 802 shown FIG. 8, or any other mobile computing device capable of displaying an electronic magazine.

At 1002, an ordered series of page images each representing a knowledge contribution about an item is received. The ordered series of page images may be received as a single file that includes all the information and instructions necessary for the mobile computing device to render the page images in the specified order. The ordered series of page images may be received from one or more computers, such as server computers 116 introduced in FIG. 1, via a network interface of the mobile computing device. The knowledge contributions represented on the respective page images may be any type of knowledge contribution discussed above such as a review, rating, ranking, evaluation, or discussion of an item.

At 1004, a page from the ordered series of page images is rendered on a display of the mobile computing device. The ordering of the page images may be based on preferences of the user.

At 1006, a page-turn animation is rendered in response to receiving a page-turn indication from the user of the mobile computing device. After rendering the page-turn animation, a next page from the ordered series of page images is rendered on the display. Thus, as the user instructs the mobile computing device to change which page is displayed, a page-turn animation may be generated as the displayed page is changed. In some implementations, each page is rendered as a full-screen image that substantially fills the display. In other implementations, a page may be rendered as a half-screen image such that two page images together substantially fill the display.

At 1008, an online purchasing page may be presented for the item shown on the page image in response to receiving the selection of a link on the page image. Thus, when the user is viewing a page that shows a knowledge contribution about an item, the page may also provide the user with a link to purchase the item. The online purchasing page may be a webpage that is accessed from the mobile computing device. Alternatively, the online purchasing page may be a page generated by an application running on the mobile computing device.

### Intermediary Account System

The personal incentives provided to productive consumers may include non-monetary benefits such as the status of guru or expert and the esteem of other members of the community. However, many of the strongest incentives may be personal pricing or discounts on items sold by the merchants. Realizing the personal pricing closes the feedback loop between consumers and business. Once the personal price or discount amount is identified, that incentive may be provided to the consumer using any technique including paper coupons that are passed of the consumer to a clerk at the merchant. However, to provide the greatest convenience and integration of this social network into the interactions between the consumers and merchants, it is desirable to make implementation of the personal incentives as effortless and transparent as possible. It is also desirable to allow consumers to access their personal pricing at merchants that are not members of this network (e.g., when the business that makes the item provides the incentive and the retailer does not participate in this system).

In some implementations, the entity providing the personal incentive for personal pricing may be different than the entities involved in the transaction. For example, a business that manufactures and item may wish to reward a consumer for his or her brand loyalty but the consumer may buy the item from a merchant that is different from the business that manufactures the item. Thus, if there is a pricing difference between the base price that the merchant offers the item and the personalized price that is available to the consumer due to the incentive provided by the business there is a need to make sure that the consumer is able to access his or her personalized pricing. This may be done by providing the consumer with a coupon or a rebate. If the consumer is using a coupon the merchant may need to request reimbursement for the value of the coupon. It is the opposite for a rebate because the consumer then has the burden of submitting the rebate. In each situation there is an entity that wishes to receive money and there is a need to protect against fraudulent or inaccurate submissions.

The personalized incentives may be implemented using an intermediary account system that includes accounts for the merchants and the consumers which are part of this social space. With the intermediary accounts the members of this community may exchange funds using deposit accounts that can be shared with traditional bank accounts but are also part of this system. In some implementations, funds may be held in escrow account and released to a deposit account only when certain conditions have been confirmed. The intermediary account system may also be used for facilitating transactions between consumers and merchants without providing an escrow function.

The intermediary account system may be implemented by the server computers 116 introduced in FIG. 1. Returning to the description of the server computers 116 in FIG. 2, several modules from the memory 204 are particularly relevant to implementing an intermediary account system. The personal pricing module 216 may determine a personal price for the item that is specific to the consumer. In some implementations the personal price is a function of the consumer's score. For example, the personal price may be based on reviews of knowledge contributions provided by the consumer. The knowledge contributions that affect the personal price of an item may be only those knowledge contributions that are associated with the item such as reviews of similar items, items from the same business, items of the same brand, etc. The reviews of the consumer's knowledge contributions may be made by other consumers, merchants, and/or businesses.

The transaction detection module 226 may identify a transaction in which the consumer purchases an item from the merchant. The transaction may be identified by a consumer identifier that identifies the consumer and an item identifier that identifies the item. The transaction may be detected by receiving a communication from a mobile device of the consumer or a POS device of the merchant. In some implementations, placement of the mobile device in proximity to a near field communication (NFC) sensor at the merchant may cause the NFC sensor to generate a signal which, when received by the communication interfaces 208, is interpreted by the transaction detection module 226 as indicating that a transaction has occurred. The NFC sensor may be an integrated part of a POS device or it may be a separate device that the merchant can add later without needing to update or modify existing POS infrastructure.

The consumer identifier and/or the item identifier may be received by the communications interfaces 208 and receiving these identifiers may itself serve as an indication that a transaction has occurred. In some cases, the consumer identifier may be received from the mobile device of the consumer or alternatively from the POS device of the merchant. Similarly, the item identifier may be received from either the mobile device of the consumer or the POS device of the merchant. For transactions conducted at a traditional brick-and-mortar retail location that has a network-enabled POS device, the consumer identifier may be received from the POS device. If the consumer is making a purchase from his or her mobile device, both the item identifier and the consumer identifier may be received from the mobile device.

A payment module 228 may provide a payment for a difference between a base price of the item and the personal price of the item. Depending on how the transaction is implemented, the payment may be made to the consumer or to the merchant. For example, if the consumer presents a coupon to the merchant and the merchant only receives the lower, personal price from the consumer then the merchant may submit the coupon in order to receive a reimbursement for the difference. Alternatively, if the consumer pays the base price which is more than the personal pricing for that consumer, the payment may be provided as a rebate to the consumer.

The escrow account module 230 may make the payment for the difference between the base price of the item and the personal price of the item into an escrow account and release the payment from the escrow account after receiving confirmation of the purchase. Depending on the technique used reduce the base price of the item, the escrow account may be an account of the consumer or an account of the merchant. Confirmation of the purchase may come from a payment source such as a credit card of the consumer, self reporting by the consumer such as submitting a copy of a receipt, or by reporting from the merchant.

The verification module 232 may provide confirmation of the purchase. This confirmation may be used to release the payment from the escrow account. The confirmation may be based on a communication received from the mobile device of the consumer or a communication received from the POS device of the merchant. For example, the consumer may take a photograph of a receipt with his or her mobile device and submit the image as confirmation of the purchase. If the POS device is connected to the network, transactions may be sent to the server computers 116 in essentially real time as the transactions are processed. If, however, POS devices at the merchant are not directly in communication with the server computers 116, the merchant may use a separate device that has a wired or wireless connection to the network in order to submit transaction confirmations to the verification module 232. This separate device, a verification device, may be wholly separate from and lack a communicative connection to the POS device. For example, the verification device may simply communicate a merchant identifier and possibly a timestamp each time a button is pressed on the verification device or each time a mobile device is bumped against the verification device. The basic data provided by the verification device may be used to double check confirmation information provided by the consumer. Additionally, a communication from a funding source used to pay for the item, such as a credit card company or a mobile payment processor, may be received by the verification module 232 as evidence that consumer purchased the item from the merchant.

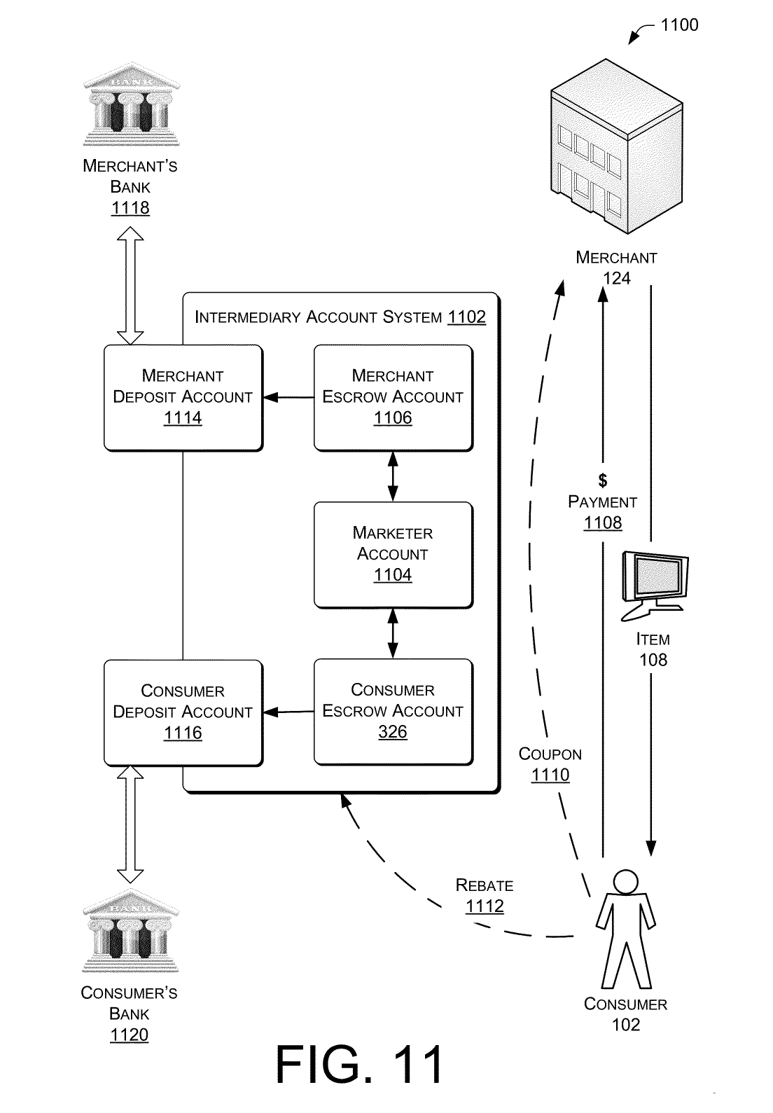

FIG. 11 shows an example architecture 1100 of the intermediary account system 1102. The intermediary account system 1102 may use a marketer to implement the personal incentives for the consumer 102. The marketer may be the business 128 shown in FIG. 1 that manufactures, assembles, distributes, imports, or is otherwise connected with the item 108. However, the marketer may also be a third-party that assists in providing payments in order to affect personal pricing in a way that is fair to both the consumer and the merchant 124. The marketer may have a marketer account 1104 in the intermediary account system 1102 from which the marketer can make payments to an account of the consumer 102 and/or an account of the merchant 124. In some implementations, the marketer account 1104 may be the same as the business account 306.

The payment 1108 by the consumer 102 for the item 108 may or may not reflect the personal pricing for the consumer 102 that is available on that item 108. If the merchant 124 is using a POS device that is connected to the server computers 116 implementing the social network described above, the POS device may be able to obtain the personal pricing and use of the intermediary account system 1102 may be unnecessary. However, the intermediary account system 1102 provides a convenient way to implement personal pricing for merchants that do not have networked POS devices or merchants that are not part of this business and consumer social space.

Assuming that the personal pricing is not automatically acquired by the POS device, the consumer 102 may obtain his or her personal pricing by submitting a coupon 1110 to the merchant 124 and paying a lower price at the time of sale or by paying the regular price to the merchant 124 and then later submitting a rebate 1112 for reimbursement.

In both cases the marketer desires to make payments for the coupon 1110 or the rebate 1112 only if the specified item 108 is sold by the merchant 124 to the consumer 102. In order to prevent fraud and provide time for confirmation, initial payments may be made from the marketer account 1104 to the merchant escrow account 1106 (for coupons 1110) or to the consumer escrow account 326 (for rebates 1110). Funds in the respective escrow accounts 1106 and 326 are released for use once the marketer has received sufficient confirmation of the transaction. Thus, the consumer 102 and the merchant 124 may be able to see the effects of submitting a coupon 1110 or rebate 1112 to the marketer relatively quickly, but the marketer may be able to have sufficient time to claw back funds from the escrow accounts 1106 and 326 in the event of fraud or a mistake.

The intermediary account system 1102 may also include a merchant deposit account 1114 and a consumer deposit account 1116 from which the merchant 124 and the consumer 102 respectively may freely add or withdraw funds without conditions imposed by the marketer. If the intermediary account system 1102 is also used to facilitate payment 1108 for the item 108, the payment 1108 may move from the consumer deposit account 1116 to the merchant deposit account 1114. Thus, the intermediary account system 1102 may function as a payment system in parallel to functioning as a system at effectuates personal pricing. Also, in implementations that do not include the security level of an escrow account, payments from the marketer account 1104 for coupons 1110 or rebates 1112 may be made directly to the merchant deposit account 1114 and/or the consumer deposit account 1116.

The merchant deposit account 1114 may exchange funds with the merchant's bank 1118 or with any other financial account of the merchant 124. Similarly, the consumer deposit account 1116 may exchange funds with the consumer's bank 1120 or with any other financial account of the consumer 102. The merchant deposit account 1114 and the consumer deposit account 1116 are part of the intermediary account system 1102, but the use of these accounts 1114 and 1116 is not limited to transactions that are facilitated by the intermediary account system 1102. Both the merchant 124 and the consumer 102 may use their respective merchant deposit account 1114 and consumer deposit account 1116 like any other financial account to make and receive payments even when those payments are not connected to the business and consumer social space.

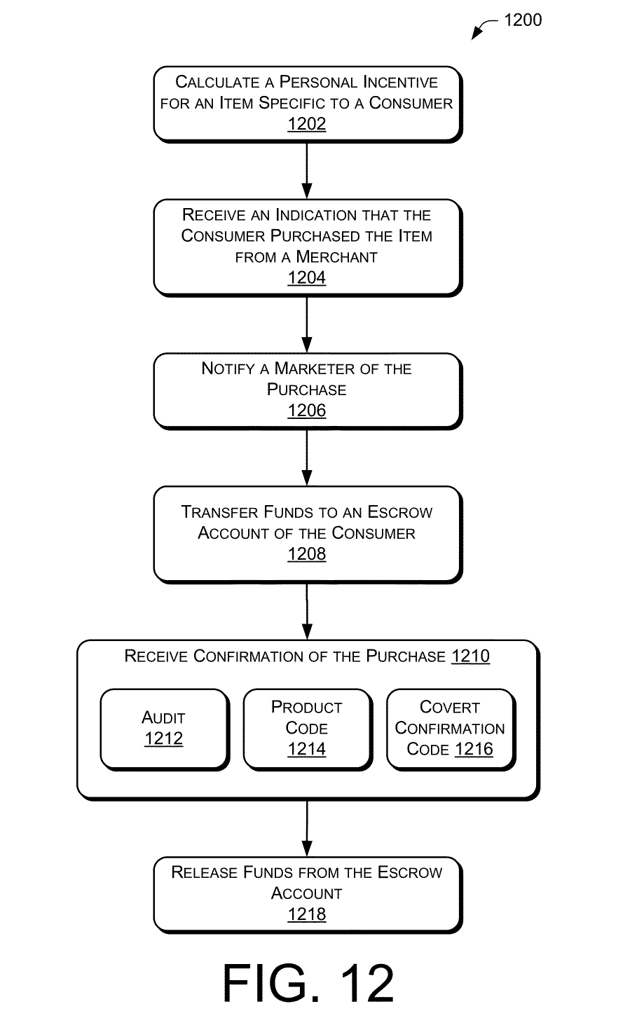

FIG. 12 shows an example process 1200 for affecting a personal price using a rebate mode. As shown, unlike the traditional rebate process which requires submission of a physical rebate with purchase evidence for each individual item purchased by the consumer, the personal incentive-based rebate in accordance with the present disclosure is either instant or semi-instant with immediate rebate redemption pending a conditional affirmation. At 1202, a personal incentive is calculated for an item. The personal incentive may be in the form of a personal price or a personal discount, rebate or credit to effectuate a personal price. The personal incentive or the personal price is specific to a consumer and based on reviews of previously generated knowledge contributions created by the consumer. The reviews of the consumer's knowledge contributions may affect the price such that relatively more favorable reviews correlate with a relatively lower personal price. The personal pricing module 216 may calculate the personal price.

At 1204, an indication that the consumer has purchased the item from a merchant is received. The transaction detection module 226 may receive the indication.

At 1206, a marketer is notified of the purchase. The marketer is responsible for modifying the transaction between the consumer and the merchant to effectuate the personal price by issuing the consumer a rebate. By modifying the transaction with a rebate the effects of the personal pricing are transparent to the merchant. Receipt of a rebate request from the consumer may be the notification of the purchase that is received by the marketer. In some implementations, the consumer may submit the rebate from a mobile device when he or she makes the purchase at the merchant. Sending notification to the marketer is optional. The marketer may pre-authorize the system to conduct the personal incentivization according to pre-agreed terms.

At 1208, in response to receiving the indication of purchase funds are transferred from an account of the marketer to an escrow account of the consumer in order to compensate the consumer for the rebate. For example, if the consumer purchased an item at a price that was $10 above his or her personal price for that item the consumer can submit the rebate and receive $10 in his or her escrow account.

At 1210, confirmation that the consumer has indeed purchased the item from the merchant is received. The confirmation may take any form that is satisfactory to the marketer or conditions preagreed to by the marketer.

For example, at 1212 the confirmation comprises an audit performed after the consumer submits the rebate. The audit may be performed randomly on a small percentage (e.g., 1% or 0.1%) of all transactions to achieve a balance between fraud deterrence and customer convenience. Therefore, the vast majority of customers will be able to obtain and use their rebates immediately. The social aspect of this system may also discourage fraud because fraud could cost the consumer any future discounts and even “earn” the consumer a higher personal price than the regular price. The audit may use the mobile device of the consumer and require the consumer to take a picture of a receipt from the purchase and submit the image to the marketer. The audit may also be performed immediately after the purchase is completed so that the consumer will be unlikely to have lost the receipt, the packaging barcode, or other evidence of the purchase.

At 1214, the confirmation may be a product code that is received from the consumer. The product code may be a code such as a universal product code (UPC) that uniquely identifies the item or the code may be something like a serial number that distinguishes each unit of the item from other units of the same item. The consumer may observe this code and enter it into his or her mobile device for transmission to the marketer. Computing systems of the marketer may record each submission and by doing so prevent the product code for a specific unit of the item from serving as confirmation for more than one transaction. This allows only one-time verification.

At 1216, confirmation may be achieved by receiving a covert confirmation code from the consumer. The covert confirmation code confirms an overt product code. Like the product code 1214, the overt product code may uniquely identify the item by distinguishing each unit of the item from other units of the same item. The covert product code may be covered by a scratch-off material, located inside product packaging, or otherwise concealed in a way that can be revealed by the consumer after purchasing the product. This may ensure that rebate submissions are received only from products that the consumer has purchased.

The product code or the covert confirmation code may be a combination of both an overt product identification code and a covert verification code. The covert verification code may be verifiable by the marketer, but remain concealed from the consumer. This technique thwarts fraudulent creation and submission of confirmation codes because the fraudulent confirmation codes will lack the necessary verification code. Example techniques for combining a covert verification code with a product code are disclosed in U.S. patent application Ser. Nos. 13/079,022, 13/079,024, 13/118,605 all entitled “Anti-counterfeiting Marking with Asymmetrical Concealment” which are each fully incorporated herein by reference.

At 1218, funds are released from the escrow account of the consumer in response to receiving satisfactory confirmation at 1210.

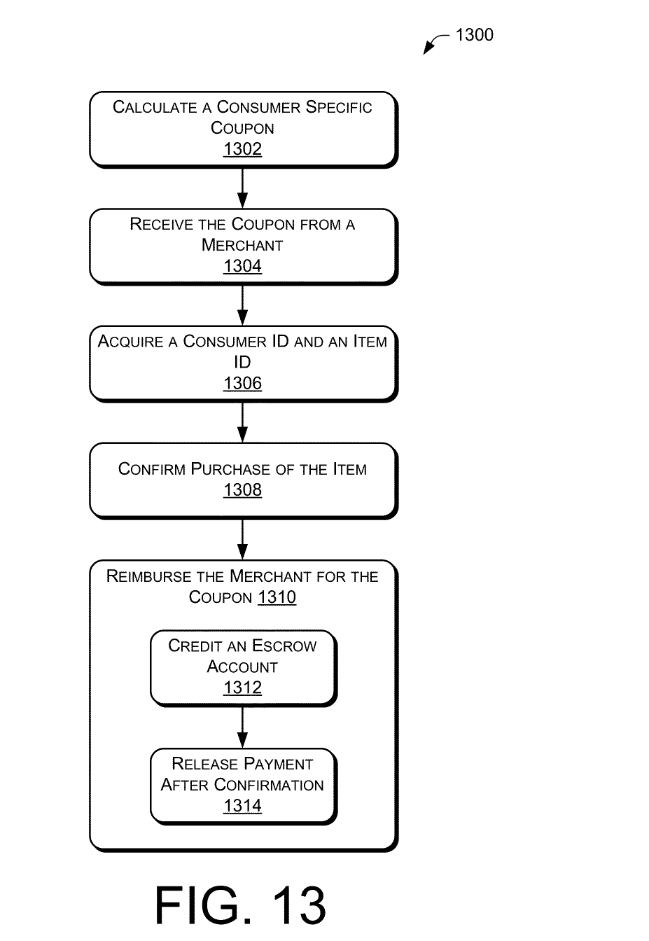

FIG. 13 shows an example process 1300 for provisioning a personal incentive to a consumer by using a coupon. At 1302, a coupon is calculated for an item. The coupon is specific to the item and to the consumer. The coupon is based on reviews of previously generated knowledge contributions created by the consumer. Relatively more favorable reviews (e.g., indicating that the consumer generated “better” knowledge contributions) may correlated with a relatively more valuable coupon (i.e., a larger discount).

The previously generated knowledge contributions may be related to items that belong to a predefined item category and the item that the consumer intends to purchase with the coupon may also belong to the same predefined item category. Thus, the item that can be purchased with the coupon “matches” the categories of items in the knowledge contributions. For example, if the knowledge contributions are about bicycles or products for use with bicycles, then the coupon would be application to an item that is associated with bicycles, but not with another category of item such as a digital camera.

At 1304, the coupon is received from a merchant. The merchant may receive the coupon from the consumer as a slip of paper, a code, a user name, an identifier of a mobile device of the consumer or the like. The merchant will sell an item to the consumer at a price determined by the coupon and (assuming the marketer of the coupon is a different entity than the merchant such as the business 128 shown in FIG. 1) the merchant will request reimbursement for the value of the coupon.

At 1306, a consumer identifier of the consumer and an item identifier of the item are acquired. These two identifiers allow computer systems to readily identify the “who” and the “what” of the transaction. Since coupons (and personal pricing in general) is specific to a given consumer and specified item, acquiring these two identifiers is useful for determining the proper coupon to apply to the transaction. The consumer identifier may be the consumer identifier 312 shown in FIG. 3.

The transaction between the consumer and the merchant may be implemented by a POS device of the merchant, a mobile device of the consumer, or both. Thus, the consumer identifier and the product identifier may come from either of those devices. In some implementations the consumer identifier is a phone number associated with a mobile device (i.e., mobile phone) of the consumer. In the same or different implementations, the consumer's mobile device may display a bar code on a display screen that encodes the consumer identifier (e.g., the phone number of that device or another consumer identifier). The POS device at the merchant may be equipped with a barcode scanner than scans the bar code displayed on the mobile device thus providing the consumer identifier to the POS device. The POS device may then send both the consumer identifier and the item identifier to the marketer.

In other implementations, such as at a merchant location that lacks POS devices or that has POS devices which are not connected to the same network as the marketer, the consumer's mobile device may be used to submit both the consumer identifier and the item identifier. For example, the consumer may take a picture of the item or of a barcode on the item and submit the image to the marketer. The system on the mobile device may automatically append the user identifier to the submission.

At 1308, the purchase of the item is confirmed by referencing the consumer identifier and the item identifier. The purchase may be confirmed by locating the consumer identifier and the item identifier in sales records sent periodically from the merchant to the marketer. The sales records may be sent in batches daily, weekly, etc. The sales records may be sent in any form including non-digital forms such as paper records.

A device under control of the consumer, such as the mobile device or another computing device, may provide confirmation by sending the consumer identifier and/or the item identifier. Since the consumer has already received the benefit of the coupon, he or she has less incentive to make a fraudulent submission than the merchant and confirmatory data sent from the consumer may be deemed sufficient to confirm the transaction.

At 1310, the merchant is reimbursed for the coupon in response to the confirmation of the purchase. The merchant may be reimbursed by receiving, at 1312, a credit to an escrow account. The escrow account may be the escrow account 306 shown in FIGS. 3 and 11. The merchant may receive a payment to the escrow account based on the value of the coupon. The payment may be for slightly more than the value of the coupon to compensate the merchant for its processing expenses. The payment to the escrow account may be made immediately upon receipt of the coupon even before verifying the validity of the coupon.

At 1314, payment is released from the escrow account of the merchant after confirming that the consumer has purchased the item. The purchase may be confirmed by any of the techniques described above.

### Tags on Items and Advertisements

In this socially networked business and consumer space there is a free flow of information between the businesses and consumers. Much of the activity in this space can be represented as data that is conveyed between various computer systems. Knowledge contributions, feedback, coupons, rebates, payments, and the like can all be transmitted electronically between computing devices. However, many of the items that are at the heart of this space are tangible objects. In order to include these items in the computer-implemented social space, machine-readable tags may be used to allow tracking and management of the various items. The tags may be read by the mobile device of a consumer, a POS device of a merchant, or another computing device. Tags may be placed on the item itself such as the machine-readable tag 106 shown in FIG. 1. Tags may also be placed on objects other than items such as the tag included in the advertisement 110 from FIG. 1.

The tags may provide a consumer or merchant additional information about an item. For example, by scanning a tag associated with an item the consumer may check his or her personal pricing for that item. Additionally, if consumers authorize tracking of their tag-scanning behavior, merchants may learn which tags on advertisements or items are frequently scanned and then the merchant can identify effective real-world ways to reach out and communicate with consumers.

The presence of tags combined with a computing device, such as a mobile device of a consumer, provides a connection between the off-line and online worlds. This connection may remove the boundary between brick-and-mortar retailers and online stores. For example, a consumer can scan the tag attached to the item at a brick-and-mortar merchant and identify online purchasing options for that same item. This may also benefit the merchants by allowing brick-and-mortar locations to stock only limited inventory which serve as demonstration models and provide a large inventory online that is accessed by the consumer scanning the tag on one of the demonstration models.

The machine-readable tags themselves may be created by manufacturers and placed on various items and advertisements. The tags may encode information according to a known standard so that any computing device compatible with the standard may access the information represented by the tags. Processing of the tags and using the tags as part of the social network may be implemented by the server computers 116.

Returning to FIG. 2, the scoring module 214 may quantify a score for the consumer based on past actions of the consumer. The past actions may include any of the actions discussed above such as generating a knowledge contributions as well as scanning a machine-readable tag on tangible object with a mobile device. Specifically, the score of the consumer relative to a particular item, brand, business, etc. may be modified based on knowledge contributions about a product made or marketed by a business that also makes or markets the item with which the machine-readable tag is associated. Thus, scanning the tag on an item offered for sale by Business E may affect the same score that is quantified based on knowledge contributions about products made by Business E. As discussed above, the extent to which the knowledge contribution affects the quantification of the score for the consumer and may be based on the ratings that other consumers or businesses assign to the knowledge contribution. Viewing advertisements and writing reviews may both contribute to a consumer's score.

The decoding module 234 decodes information encoded in the machine-readable tag. In some implementations, the mobile device of the consumer may scan a machine-readable tag and pass data representing the scanned tag to the communications interfaces 208 for processing by the decoding module 234. Thus, the mobile device may simply scan a tag and the server computers 116 may perform the decoding in order to access the information stored in the tag.

The sales module 236 may generate an offer for sale of an item, or related items, indicated in the information encoded in the machine-readable tag. For example, the consumer may scan a tag that is associated with a printer and the sales module 236 may generate an offer for ink cartridges that are compatible with the printer. In some situations, the consumer may scan the tag on an item or advertisement because he or she is interested in purchasing the item associated with the tag. When the tag is submitted to the decoding module 234 for analysis, this may cause the sales module 236 direct an offer to sell the item, or the related item, to the consumer.

The offer may indicate a personal price or a personal incentive effectuating a personal price for the item or the related item. The personal price may be based on a score of the consumer as determined by the scoring module 214. For example, the consumer may be considering purchasing an item in a brick-and-mortar merchant and a price tag on the item may not reflect the personal pricing available to the consumer. In order to learn his or her “true” price for that item the consumer may scan the tag on the item. As discussed above, the personal pricing module 216 may calculate the personal price for the consumer. The personal price may be less than a base price for the item, or a related item, that is offered for sale. However, it is also possible for the personal price to be higher than the base price. For example, the business may choose to raise the personal price for consumers that repeatedly generate critical knowledge contributions about its products.

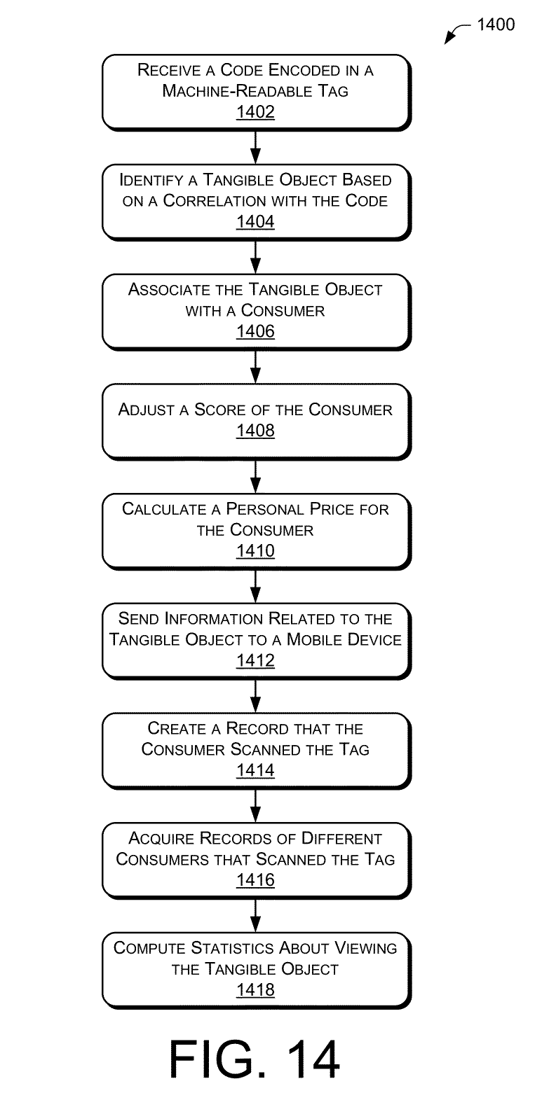

FIG. 14 shows an example process 1400 for adjusting the score of a consumer based on viewing of an advertisement. The adjustment of the score may be implemented by the scoring module 214.

At 1402, the code encoded in a machine-readable tag on tangible object is received from the mobile device of the consumer. The code may contain information that identifies a brand, a business, or category of items. The code may be sent from the mobile device of the consumer when the mobile device scans the tag. Scanning the tag may include taking a picture of a linear or two-dimensional barcode which is analyzed by software on the mobile device, receiving a radio signal from an RFID tag, or any other type of scanning in which information encoded in the tag is transferred to the mobile device. The code may be received from the mobile device via a network connection that may use wired and/or wireless communication.

At 1404, a tangible object is identified based on a stored correlation between the code and the tangible object. For example, the decoding module 234 may access a lookup table and identify a tangible object that is associated with the code included in the tag. As shown in FIG. 1, the tangible object may be an item 108 or an advertisement 110. The advertisement 110 may be a poster or image representing an item. The item 108 may be a unit that is available for sale or a demonstration model that is not the actual unit that the consumer is able to purchase. Thus, in some instances the distinction between the item 108 and the advertisement 110 may be blurred.

At 1406, the tangible object identified by the code is associated with the consumer. The act of scanning the tag may create a link between the consumer operating the mobile device and the tangible object to which the machine-readable tag is affixed.

At 1408, a score of the consumer is adjusted. This adjustment may be implemented by the scoring module 214. Due to the association between the tangible object and the consumer created at 1406, the consumer may earn a higher score for scanning the tag. For example, if a business wishes to reward the consumer for viewing its advertisements, the consumer's score may increase when he or she scans a tag on an item or advertisement of the business.

At 1410, a personal price of the item is calculated for the consumer. The personal price may be based on the score of the consumer. Therefore, the result of scanning a tag may be the consumer receiving a lower personal price or the item or on a related item. The personal price may be calculated by the personal pricing module 216.

At 1412, information related to the tangible object is sent from networked computer systems, such as the server computers 116, to the mobile device. The information may include an offer to sell an item that is advertised in the advertisement with the tag. For example, the consumer may scan the tag on a poster advertising a product and receive a page on his or her mobile device that provides a way to purchase the advertised product. Similarly, if the tag is placed on an item, scanning the tag may cause the mobile device of the consumer to receive information that offers that item or a similar item for sale.

At 1414, a record is created that indicates that the consumer scanned the machine-readable tag. This record may be associated with the consumer account of the consumer, the business account of a business that is associated with the item or with another data store accessible by the server computers 116. The record may be used to track activity of the consumer and/or activity of the tag.

At 1416, additional records of different consumers scanning the machine-readable tags are acquired. With this information it becomes possible to determine who is interacting with the tag, when consumers are scanning the tag, and how often scanning of the tag is converted into a sale.

At 1418, statistics about viewing of the tangible object are computed. The statistics may include the times of viewing, the frequencies of viewing, characteristics of consumers that scanned the tag, amount of sales generated from scanning of the tag, and the like.

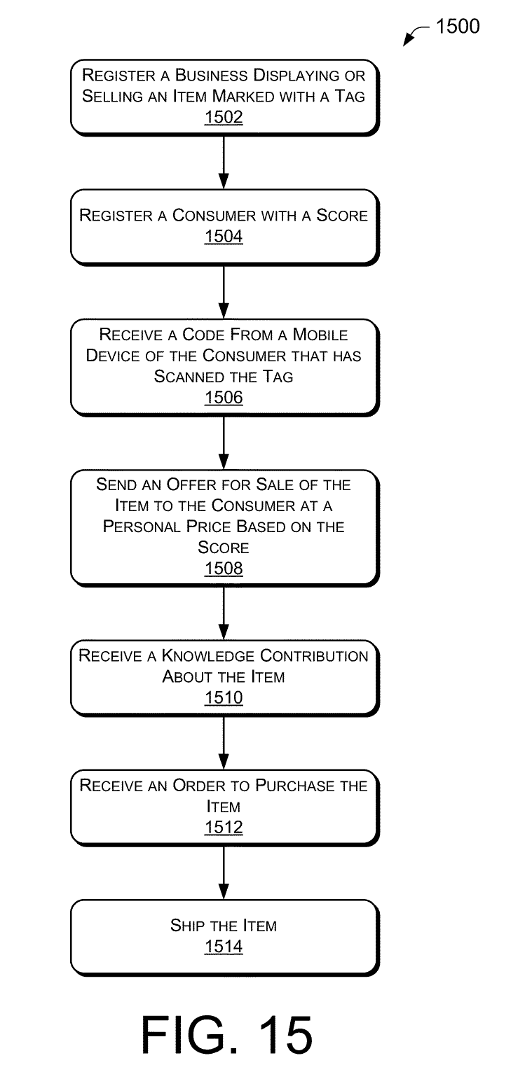

FIG. 15 shows an example process 1500 for sending an offer to sell an item to the consumer when the consumer scans a machine-readable tag associated with the item. Process 1500 may be implemented in part by the sales module 236.

At 1502, a business displaying or selling an item at a brick-and-mortar location is registered. The registration may include creating a business account 302 for the business as store shown in FIG. 3. The item that is being sold may be marked with a machine-readable tag encoding information that identifies the item as well as potentially including additional information about the item.

At 1504, a consumer is registered. Registering the consumer may include creating a consumer account 310 for the consumer in the consumer accounts 120 data store shown in FIG. 3. The consumer is associated with a score, such as the consumers score 320, that is based on past actions of the consumer in relation to the business. For example, the past actions may include purchasing items from the business, generating knowledge contributions about items sold by the business, and scanning tags associated with the business.

At 1506, a code is received from a mobile device of the consumer in response to the mobile device scanning the machine-readable tag that is marking the item. The code may be received by the communication interfaces 208 of the server computers 116. The code received from the mobile device includes information encoded in the machine-readable tag and an identifier of the consumer. The identifier of the consumer may be obtained from the memory of the mobile device. Information that is encoded in the machine-readable tag may be processed by the decoding module 234.

At 1508, an offer for sale of the item or a related item is sent to the mobile device. The server computers 116 may send the offer directly by using the sales module 236 or the server computers 116 may contact the business or another merchant and instruct a third party to send the offer for sale to the mobile device. The offer for sale indicates a personal price that is based on the score of the consumer. Thus, the personal price is personal to the consumer and may be calculated, as discussed above, by the personal pricing module 216.

In some implementations the business displays an item for sale but does not offer the item directly for sale from the brick-and-mortar location. The brick-and-mortar location may function as a showroom or display area for items that are representative of the inventory of the business. The consumer may interact with the representative items and learn about features available in different items that are not shown at the brick-and-mortar location. Thus, the tag on one item may provide an opportunity to purchase a different unit of the same item or a unit of a similar but not identical item. The item and the related item may be related by belonging to the same category of items such as brand, manufacture, or item function.

At 1510, a knowledge contribution about the item is received from the consumer. This offers an optional opportunity to receive the knowledge contribution from the mobile device when the mobile device and the consumer are still located at the business. However, it is noted that the knowledge contribution may be either generated by the consumer based on the consumer's experience with the item after he or she has purchased the item (and sent from any other computing device accessible by the consumer) or based on the consumer reviewing the item at the business. The knowledge contribution may be automatically stored in association with an identifier that identifies the item. The knowledge contribution capture module 210 may be responsible for receiving a knowledge contribution and storing the knowledge contribution. In some implementations, the knowledge contribution may be stored as part of the consumer account 310.

At 1512, an order is received from the mobile device to buy the item or the related item at the personal price. The user may scan the tag on the item and place an order from his or her mobile device to buy that item or the related item. If the business is designed as a showroom which is not intended to sell items from an on-site inventory, the business may simply provide demonstration items with tags and rely on consumers using their own mobile devices to process online purchases of items. Thus, the business may operate without a POS device on premises.

At 1514, the item or the related item may be shipped to the consumer. The business itself may do the shipping or it may instruct another party such as a shipping company to ship the item. Shipping the item to the consumer may allow the consumer to receive the item without having to provide the consumer a unit from inventory at the brick-and-mortar location.

### CONCLUSION

These processes discussed above are each illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. Computer-readable storage media storing instructions that, when executed on a computing device, cause the computing device to perform acts comprising:
calculating a personal incentive for an item that is specific to a consumer, the personal incentive based at least in part on reviews of a previously generated knowledge contribution created by the consumer, wherein relatively more favorable reviews correlate with a relatively higher personal incentive;
receiving an indication that the consumer has purchased the item from a merchant;
responsive to receiving the indication, transferring funds from an account of the marketer to an escrow account of the consumer to compensate the consumer;
receiving confirmation that the consumer has purchased the item from the merchant; and
responsive to receiving confirmation, releasing the funds from the escrow account of the consumer.

2. The media as recited in claim 1, wherein the confirmation comprises an audit performed after the consumer submits the rebate.

3. The media as recited in claim 1, wherein the confirmation comprises receiving a product code from the consumer, the product code uniquely identifying the item by distinguishing each unit of the item from other units of the same item.

4. The media as recited in claim 1, wherein the receiving the confirmation comprises receiving from the consumer a covert confirmation code which confirms an overt product code, the product code uniquely identifying the item by distinguishing each unit of the item from other units of the same item.

5. A method implemented on one or more computer systems for providing a coupon to a consumer, the coupon applicable to purchasing of an item, the method comprising:
calculating, by the one or more computer systems, the coupon for the item that is specific to the consumer, the coupon based at least in part on reviews of a previously generated knowledge contribution created by the consumer, wherein relatively more favorable reviews correlate with a relatively more valuable coupon;
receiving the coupon from a merchant;
acquiring a consumer identifier of the consumer and an item identifier of the item;
confirming that the consumer has purchased the item from the merchant by referencing the consumer identifier and the item identifier; and
responsive to the confirming, reimbursing the merchant for the coupon.

6. The method as recited in claim 5, wherein the consumer identifier comprises a phone number associated with a mobile device of the consumer.

7. The method as recited in claim 5, wherein acquiring the consumer identifier comprises receiving, from a point-of-sale (POS) device at the merchant a scan of a bar code displayed on a display of a mobile device of the consumer, the bar code encoding the consumer identifier.

8. The method as recited in claim 5, wherein acquiring the consumer identifier comprises receiving the consumer identifier and the item identifier from a POS device at the merchant.

9. The method as recited in claim 5, wherein the acquiring comprises receiving the consumer identifier and the item identifier from a mobile device of the consumer.

10. The method as recited in claim 5, wherein the acquiring comprises receiving the item identifier from a POS device at the merchant and receiving the consumer identifier from a mobile device of the consumer.

11. The method as recited in claim 5, wherein the previously generated knowledge contributions created by the consumer are each related to items that belong to a predefined item category and the item that the consumer purchases with the coupon also belongs to the predefined item category.

12. The method as recited in claim 5, wherein the confirming comprises locating the consumer identifier and the item identifier in sales records sent periodically from the merchant to the marketer.

13. The method as recited in claim 5, wherein the confirming comprises receiving at least one of the consumer identifier or the item identifier from a device under the control of the consumer.

14. The method as recited in claim 5, wherein reimbursing the merchant comprises:
crediting an escrow account of the merchant with a payment based on a value of the coupon upon receipt of the coupon; and
releasing the payment from the escrow account after confirming that the consumer has purchased the item.

15. A computing device for enabling a consumer to purchase an item at a personal price specific to the consumer, the device comprising:
a processing unit;
memory coupled to the processing unit;
one or more communications interfaces, coupled to the processing unit, to receive a consumer identifier that identifies the consumer and an item identifier that identifies the item;
a personal pricing module, stored in the memory and executable on the processing unit, to determine a personal price for the item that is specific to the consumer;
a transaction detection module, stored in the memory and executable on the processing unit, to identify a transaction in which the consumer purchases the item from a merchant, wherein the transaction is identified based at least on the consumer identifier and the item identifier; and
a payment module, stored in the memory and executable on the processing unit, to provide a payment for a difference between a base price of the item and the personal price of the item.

16. The device as recited in claim 15, wherein the one or more communications interfaces receives the consumer identifier from at least one of a mobile device of the consumer or a point-of-sale (POS) device of the merchant.

17. The device as recited in claim 15, wherein the one or more communications interfaces receive the item identifier from at least one of a mobile device of the consumer or a POS device of the merchant.

18. The device as recited in claim 15, wherein the personal pricing module determines the personal price based at least in part on reviews of a knowledge contribution provided by the consumer, the reviews made by merchants and/or consumers, the knowledge contribution associated with the item.

19. The device as recited in claim 15, wherein the transaction detection module identifies the transaction based at least in part on a mobile device of the consumer being placed in proximity to a near-field communication (NFC) sensor at the merchant that causes the NFC sensor to generate a signal which is received at the one or more communications interfaces.

20. The device as recited in claim 15, further comprising an escrow account module, stored in the memory and executable on the processing unit, to make the payment for the difference between the base price of the item and the personal price of the item into an escrow account and release the payment from the escrow account after receiving confirmation of the purchase.

21. The device as recited in claim 15, further comprising a verification module, stored in the memory and executable on the processing unit, to provide confirmation of the purchase, the confirmation based at least in part on a communication received from a mobile device of the consumer, a communication received from a POS device of the merchant, a communication received from a verification device at the merchant which is separate from and lacks a communicative connection to the POS device, or a communication from a funding source used to pay for the item.
